(19) United States
(12) Patent Application Publication
(10) Pub. No.: US 2020/0225903 A1
(43) Pub. Date: Jul. 16, 2020

(54) MODULAR DISPLAY SYSTEM

(71) Applicant: Noy Cohen, Tel Aviv (IL)

(72) Inventor: Noy Cohen, Tel Aviv (IL)

(21) Appl. No.: 16/720,556

(22) Filed: Dec. 19, 2019

Related U.S. Application Data
(60) Provisional application No. 62/790,610, filed on Jan. 10, 2019.

(51) Int. Cl. G06F 3/14; G06F 3/041; G09G 5/12

(52) U.S. Cl. CPC G06F 3/1446; G06F 3/041; G09G 5/12; G09G 2370/16; G09G 2320/0606; G09G 2300/026; G09G 2354/00

(57) ABSTRACT

Display systems comprising a display tiles array comprising a plurality of display tiles and a main processing unit (MPU), wherein each display tile is connected electrically to at least one other of the plurality of display tiles, wherein the MPU is coupled electrically to one of the display tiles via an electrical connection, wherein the MPU may transmit information to the display tiles array via the electrical connection and wherein the transmitted information may propagate to particular display tiles in the display tiles array, such that each particular display tile may receive and display information intended to the respective particular display tile.

### CROSS REFERENCE TO RELATED APPLICATIONS

This application claims priority from U.S. Provisional Patent Application No. 62/790,690 filed on Jan. 10, 2019, which is expressly incorporated herein by reference in its entirety.

### FIELD

Embodiments disclosed herein relate in general to digital display devices, to digital display walls and digital canvas systems, and to methods for assembling and operating such displays and systems.

### BACKGROUND

Display systems are a common commodity, owned by hundreds of millions of consumers around the world. In recent years, display systems and in particular televisions (TVs), have become more and more sophisticated, offering increasingly advanced panel technologies, such as liquid-crystal display (LCD), light-emitting diode (LED) and organic LED (OLED), with improved resolution (for example, 4K and 8K devices are available in the market) image quality, response time, connectivity to the Internet, abundance of applications that stream different types of content, and a convenient user interface. Display dimensions are also increasing, as consumers desire larger and larger displays to enjoy better and more immersive viewing experience. However, consumer display sizes are limited by the ability to manufacture a single, large, uniform display panel, and are typically below 2500-3000 mm in diagonal (though costly exceptions exist). Despite the increase in size, the basic shape and form factor of consumer displays has remained largely unchanged—displays are typically rectangular in shape, and most have roughly a 16:9 aspect ratio, which fits the aspect ratio of broadcasted content (whether over IP, cables, satellite or over the air) and of content distributed over digital media (e.g. DVDs).

In parallel with these advancements in consumer televisions and displays, in the business and professional market, advanced display systems are nowadays used for digital signage. Multiple displays are sometimes hooked together to create video walls or digital canvas systems (which may also offer interaction). These systems typically include several commercial displays that are mounted one next to each other on a precision mounting rack and are connected each to a player device. In turn, all displays and player devices are connected to a central server that distributes the displayed data among the connected displays (see for example U.S. Pat. Nos. 10,079,963 and 9,148,614). The displays are sometimes designed specifically to have narrow bezels to provide enhanced, and as much as possible uninterrupted viewing experience. These video wall systems are often bulky, inflexible, very costly, require complicated mounting systems and mandate expert installation.

Today, there is no viable solution for a consumer display system that can span a very large size (for example, several times larger than 2500 mm diagonal), can provide a digital canvas experience, is flexible in shape, easy to assemble and affordable.

### SUMMARY

In various illustrative embodiments there are provided display systems comprising a display tiles array comprising a plurality of display tiles and a main processing unit (MPU), wherein each display tile is connected electrically to at least one other of the plurality of display tiles, wherein the MPU is coupled electrically to one of the display tiles via an electrical connection, wherein the MPU may transmit information to the display tiles array via the electrical connection, and wherein the transmitted information may propagate to particular display tiles in the display tiles array, such that each particular display tile may receive and display information intended to the respective particular display tile.

In some illustrative embodiments, the transmitted information includes synchronized video frames.

In some illustrative embodiments, the transmitted information includes still images.

In some illustrative embodiments, each display tile is connected magnetically to at least one other display tile of the plurality of display tiles.

In some illustrative embodiments, each display tile is mounted magnetically on a ferromagnetic surface.

In some illustrative embodiments, at least one of a plurality of display tiles may be touch sensitive and have touch-screen abilities.

In some illustrative embodiments, a display system further comprises user interaction means for a user to interact with the display system to control display system parameters. In some embodiments, the user interaction may include touch gestures on touch sensitive display tiles. In some embodiments, the user interaction is done through a mobile application. In some embodiments, the user interaction is done through a remote control. In some embodiments, the user interaction is done through voice commands. In some embodiments, the user interaction is done through a keyboard and mouse interface.

In some embodiments, each display tile includes a tile processing unit. In some embodiments, each display tile includes a non-volatile memory. In some embodiments, each display tile includes data and control interfaces. In some embodiments, at least some of display tiles include a display. In some embodiments, at least some of display tiles include an optical element to mitigate observed bezels between neighboring display tiles.

In some embodiments, the information propagates between the MPU and the plurality of display tiles and between display tiles in the display tiles array by means of messages that are routed to their destination display tile according to routing tables in each display tile.

In some embodiments, the MPU maps the array of display tiles by sending identification messages and constructs a representation of display tiles array, including information about the type of each display tile and its connections to other display tiles in plurality of display tiles.

In some embodiments, the display tiles are square-shaped with width and height between 50 mm and 300 mm.

In some embodiments, some display tiles include an optical element that applies magnification to display tile image, such that bezels surrounding the display tiles appear narrower to an observer.

In some embodiments, some display tiles include an optical element that applies magnification to display tile image, such that bezels surrounding the display tiles are not observed by an observer.

In some embodiments, display tiles include connectors on each side that connect magnetically to connectors in neighboring display tiles. The connectors in each display tile may include permanent magnets oriented with outward-facing magnetic poles alternating between north and south along the circumference of the display tile.

In some embodiments, a display system includes an MPU that is an integral part of the display tiles array, with display capabilities. In such case, the MPU may be considered an MPU tile. Such an MPU tile may have different sizes.

In some embodiments, such MPU tile may have touch-sensitive display and may be able to sense user gestures.

In some embodiments, an MPU tile may have a depression and include an electrical plug to support mounting it on top of an electrical socket.

In some embodiments, an MPU may send frame data to some display tiles, or to all display tiles over wireless communication channels.

### BRIEF DESCRIPTION OF THE DRAWINGS

Non-limiting examples of embodiments disclosed herein are described below with reference to figures attached hereto, that are listed following this paragraph. Identical structures, elements or parts that appear in more than one figure may be labeled with a same numeral in the figures in which they appear. The drawings and descriptions are meant to illuminate and clarify embodiments disclosed herein and should not be considered limiting in any way.

FIG. 1A shows a diagram illustrating a modular display system;

FIG. 1B shows a diagram illustrating usage of a modular display system;

FIG. 2A shows a first illustrative configuration of a modular display system;

FIG. 2B shows a second illustrative configuration of a modular display system;

FIG. 2C shows a third illustrative configuration of a modular display system;

FIG. 2D shows a fourth illustrative configuration of a modular display system;

FIG. 3A shows a diagram illustrating how display tiles are mounted to a mounting surface on a wall;

FIG. 3B shows a diagram illustrating how display tiles are mounted to a mounting surface on two walls with a right-angle corner;

FIG. 3C shows a diagram illustrating how a display tiles array that includes an MPU as an integral part is mounted on a wall;

FIG. 3D shows a diagram illustrating a display tiles array with an MPU as an integral part, that is mounted on top of an electrical socket;

FIG. 4 shows a structural block diagram of an MPU;

FIG. 5 shows a functional block diagram of an MPU;

FIG. 6A shows a schematic perspective view of a display tile;

FIG. 6B shows a schematic transparent perspective view of a display tile;

FIG. 6C shows a schematic back side view of a display tile;

FIG. 6D shows illustrative options for connecting display tiles perpendicular to each other;

FIG. 6E shows illustrative a display tiles array that includes two co-planar display tiles and one display tile perpendicular to them;

FIG. 6F shows a schematic perspective-view of a cross section of a display tile;

FIG. 6G shows a schematic side-view of a cross section of a display tile that includes an optical element;

FIG. 6H shows a schematic side-view of a cross section of a display tile that includes no optical element;

FIG. 7A shows a diagram illustrating a how an image displayed on display tiles array may appear to an observer with display tiles having with no optical element;

FIG. 7B shows a diagram illustrating a how an image displayed on display tiles array may appear to an observer with display tiles having an optical element, resulting in thinner observable bezels between display tiles;

FIG. 7C shows a diagram illustrating a how an image displayed on display tiles array may appear to an observer with display tiles having an optical element, resulting in no observable bezels between display tiles;

FIG. 8A shows a schematic diagram of light rays originating from display tile active area and observed by an observer;

FIG. 8B shows a schematic diagram of light rays originating from display tile active area, with display tile including an optical element, and observed by an observer;

FIG. 9A shows a ray diagram of display tile and observer with corresponding image simulation, with display tile including no optical element;

FIG. 9B shows a ray diagram of display tile and observer with corresponding image simulation, with display tile including a Fresnel optical element;

FIG. 9C shows a ray diagram of display tile and observer with corresponding image simulation, with display tile including a lens optical element;

FIG. 9D shows a ray diagram of display tile and observer with corresponding image simulation, with display tile including an optical element with a polynomial surface sag;

FIG. 9E shows a ray diagram of display tile and observer with corresponding image simulation, with display tile including an optical element with a polynomial surface sag that is mostly flat and curves towards its borders;

FIG. 10A shows a ray diagram of display tile and observer with corresponding image simulation, with display tile including a thin optical element with a polynomial surface sag;

FIG. 10B shows a ray diagram of display tile and observer, observing the display tile at an angle, with corresponding image simulation for on-axis and off-axis observation, with display tile including a thin optical element with a polynomial surface sag;

FIG. 11 shows a schematic diagram showing embodiments of display tiles arrays with triangular display tiles and with hexagonal display tiles;

FIG. 12 shows a structural block diagram of a display tile;

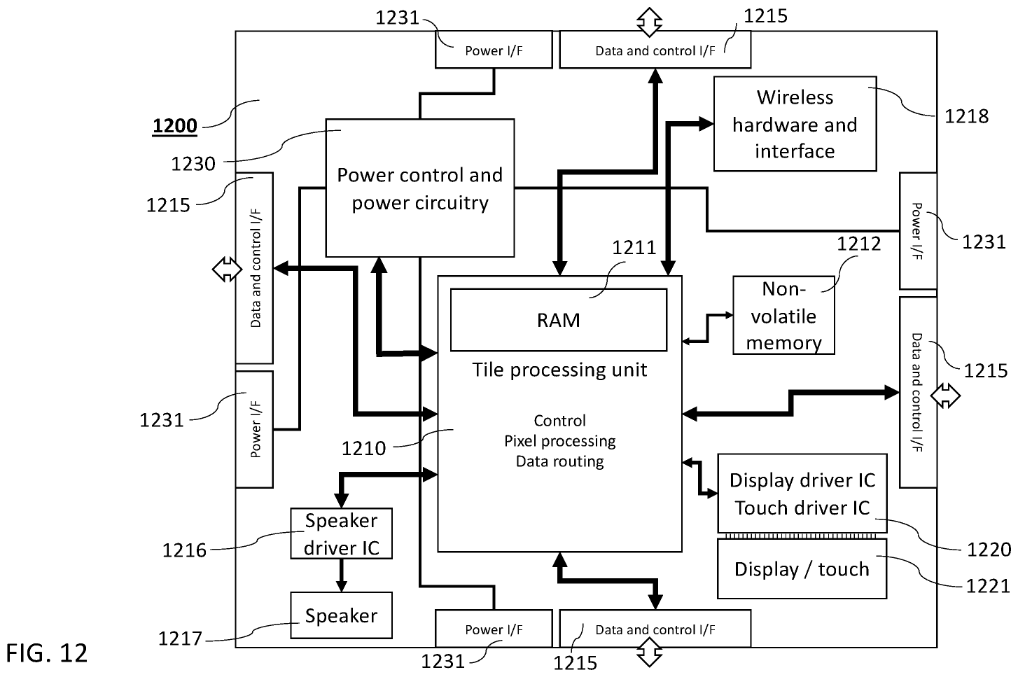

FIG. 13 a schematic diagram of an array of display tiles connected to an MPU and the connectivity between them;

FIG. 14 shows a workflow diagram of mapping a display tiles array by an MPU;

FIG. 15 shows a workflow diagram of generating routing tables for display tiles by an MPU;

FIG. 16A shows a workflow diagram of updating MPU and display tiles routing tables when an existing display tile is disconnected;

FIG. 16B shows a workflow diagram of updating MPU and display tiles routing tables when a new display tile is connected;

FIG. 17 shows a workflow diagram of general operation of an MDS and for factors that affect how displayed frame is updated;

FIG. 18A shows a workflow diagram of initializing wireless communication channels between MPU and display tiles;

FIG. 18B shows a workflow diagram of updating MPU when an existing display tile using wireless communication channel is disconnected;

FIG. 18C shows a workflow diagram of updating MPU when a new display tile with wireless communication capability is connected to display tiles array;

FIG. 19A shows a schematic view of an MPU tile;

FIG. 19B shows a schematic view of an MPU tile designed for mounting on top of an electrical socket.

### DETAILED DESCRIPTION

It is desirable for display systems to be flexible in size and shape so that they can fit different spaces (and support easy reconfiguration after initial installation), to have the ability to span entire walls of different sizes and shapes (with total size on the order of many tens of thousands of square millimeters), to provide seamless viewing experience with no visible bezels, to have resolution that supports viewing from both close range and far range, and to offer advanced display capabilities such as multi streaming support from various streaming devices.

In this disclosure, reference to “an embodiment”, “embodiments”, “one embodiment”, “some embodiments”, “certain embodiments” should be interpreted to mean that a particular structure or feature described in said embodiment is included in at least one embodiment of the disclosed subject matter. Multiple references to “an embodiment” or to “one embodiment” should not necessarily imply the same embodiment.

System embodiments described herein aim to serve as modular displays with advanced capabilities and features for consumer and professional usage, while fulfilling the desirable properties mentioned above.

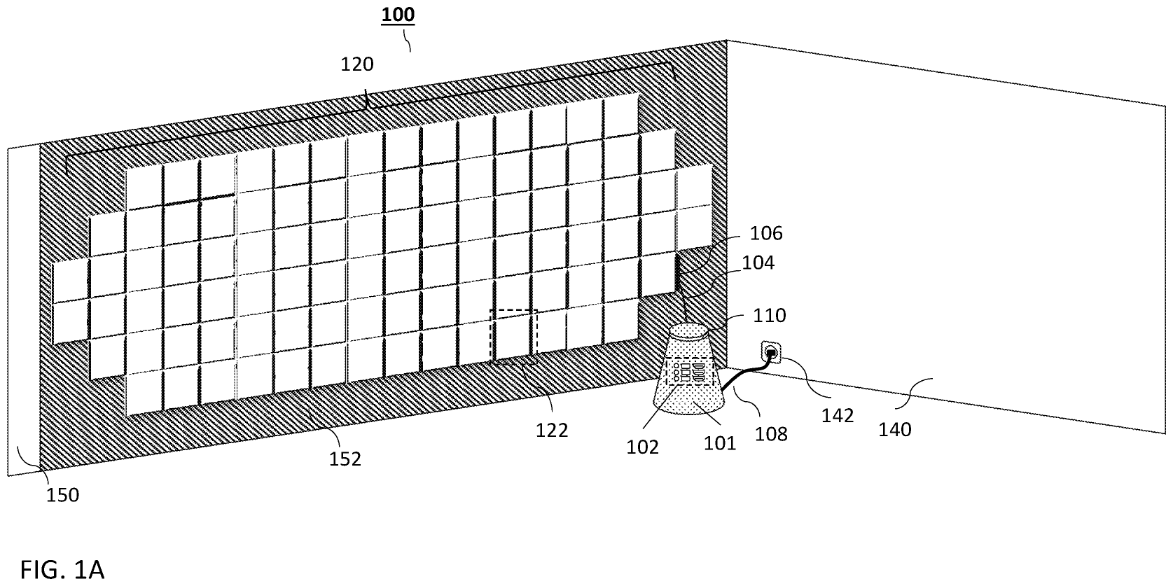

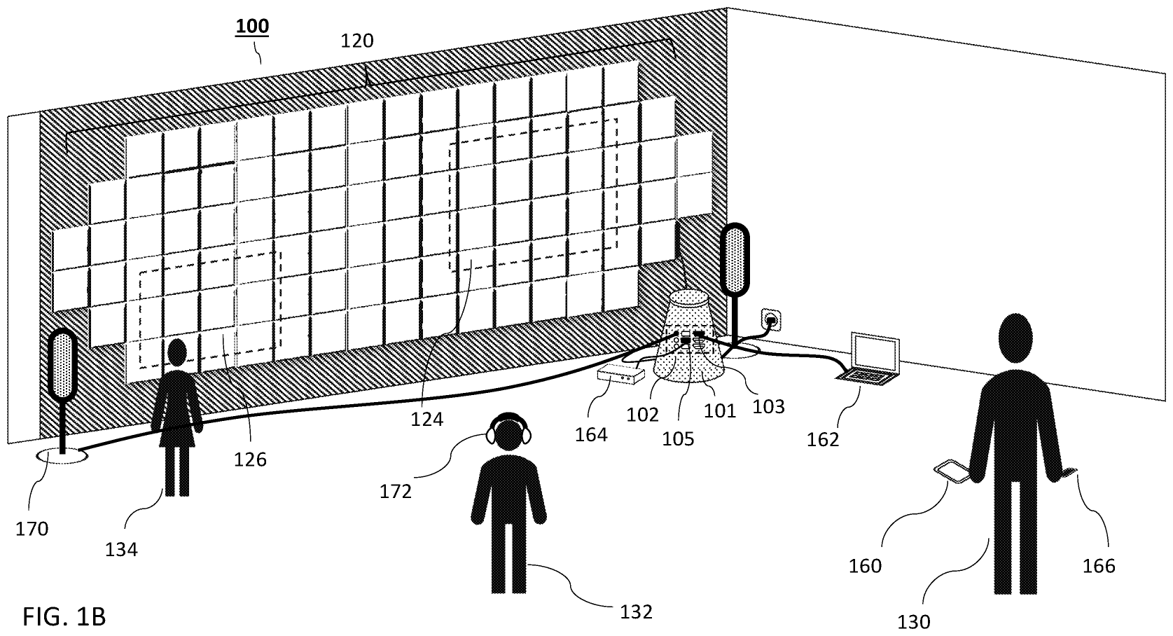

FIG. 1A shows an illustration of the proposed modular display system (MDS) 100, according to an illustrative embodiment disclosed herein. MDS 100 comprises a plurality of display tiles array or simply (“tile array”) 120 and a main processing unit (MPU) 101.

In FIG. 1A, a wall 150 serves as a mounting surface for display tiles array 120. In some embodiments, wall 150 is covered by a ferromagnetic layer 152. In some embodiments, ferromagnetic layer 152 may include one or more layers of ferromagnetic paint applied on wall 150. In some embodiments, ferromagnetic layer 152 may include a ferromagnetic wallpaper covering at least part of wall 150. In other embodiments, ferromagnetic layer 152 may be a ferrous sheet covering at least part of wall 150. Layer 152 may have different colors and textures. In some embodiments, ferromagnetic layer 152 may be an integral part of MDS 100. In some embodiments, tile array 120 may be mounted on wall 150 by other mechanical means, such as screws, bolts, hooks, Velcro-like fasteners, glue (reusable or permanent), etc. (not shown). In subsequent sections, references to ferromagnetic layer 152 attached to a wall, and to permanent magnets used to mount display tiles or other system components onto said ferromagnetic layer should be understood as referring to one illustrative method of mounting MDS 100 components on a wall, among other mounting methods, such as the ones mentioned earlier. Tile array 120 may be disposed on wall 150 in any shape, with any number of tiles. FIGS. 1A, 1B, 2A, 2B, 3, 7A, 7B, 7C show only a limited number of examples of mounting display tiles on a surface such as wall 150.

Tile array 120 comprises a plurality of individual display tiles such as, for example, a display tile 122. In an embodiment, each tile in tile array 120 may have a permanent magnet on its back side, facing wall 150. Display tiles in tile array 120, may attach to ferromagnetic layer 152 via a magnetic attraction force, which exists between the permanent magnet on display tiles in tile array 120 and ferromagnetic layer 152.

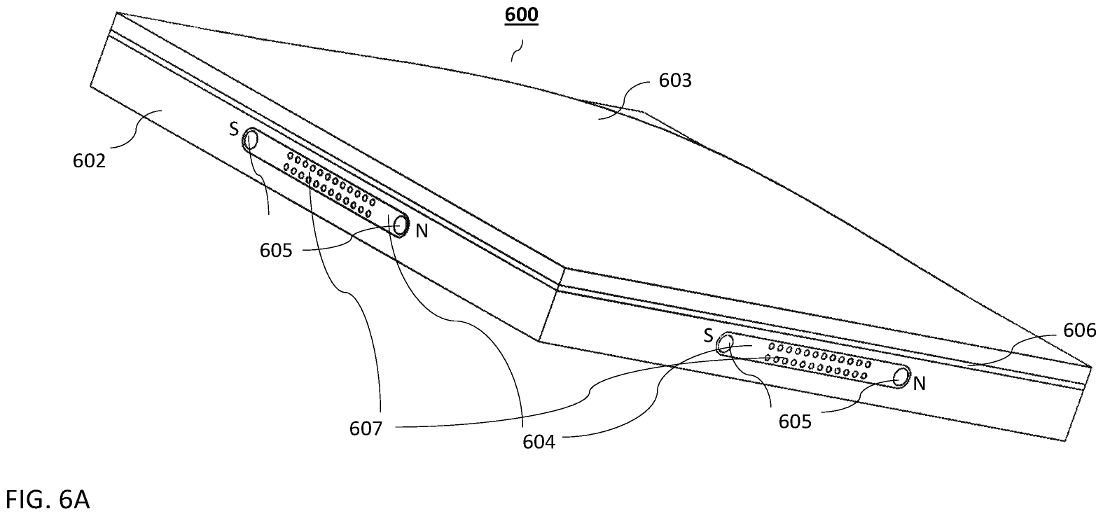

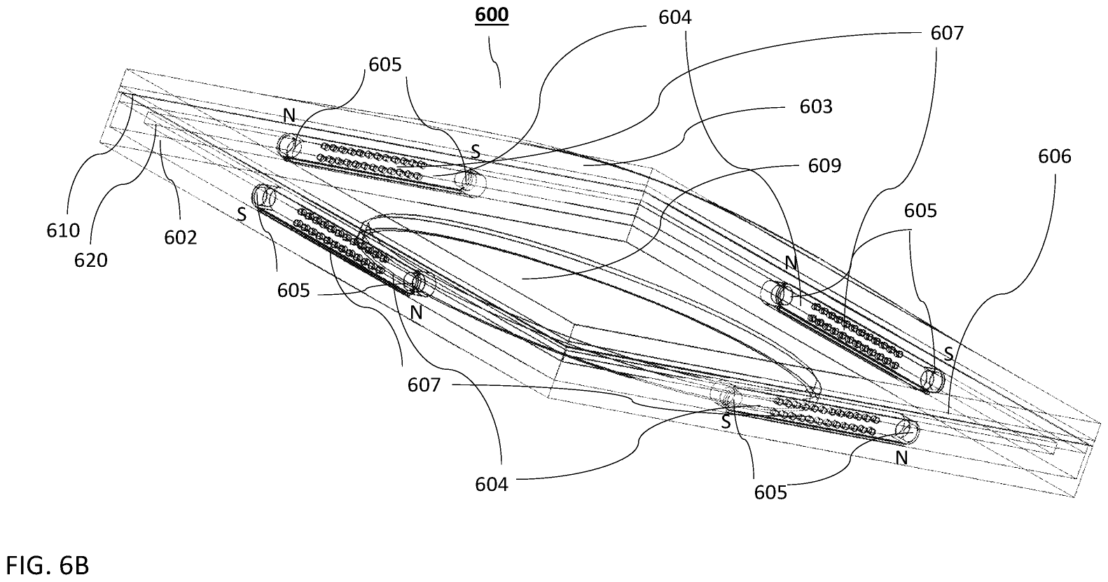

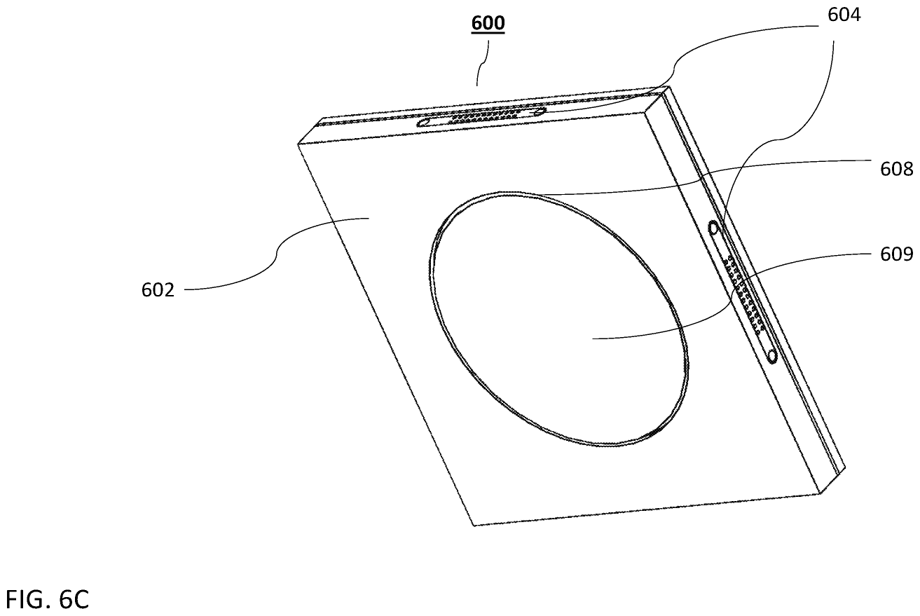

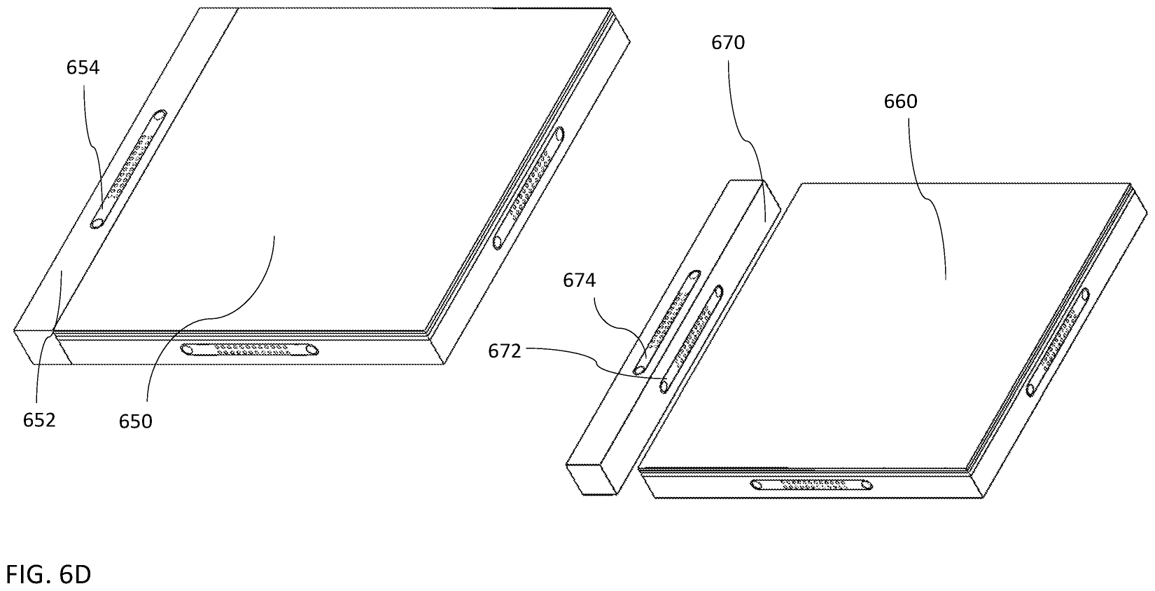

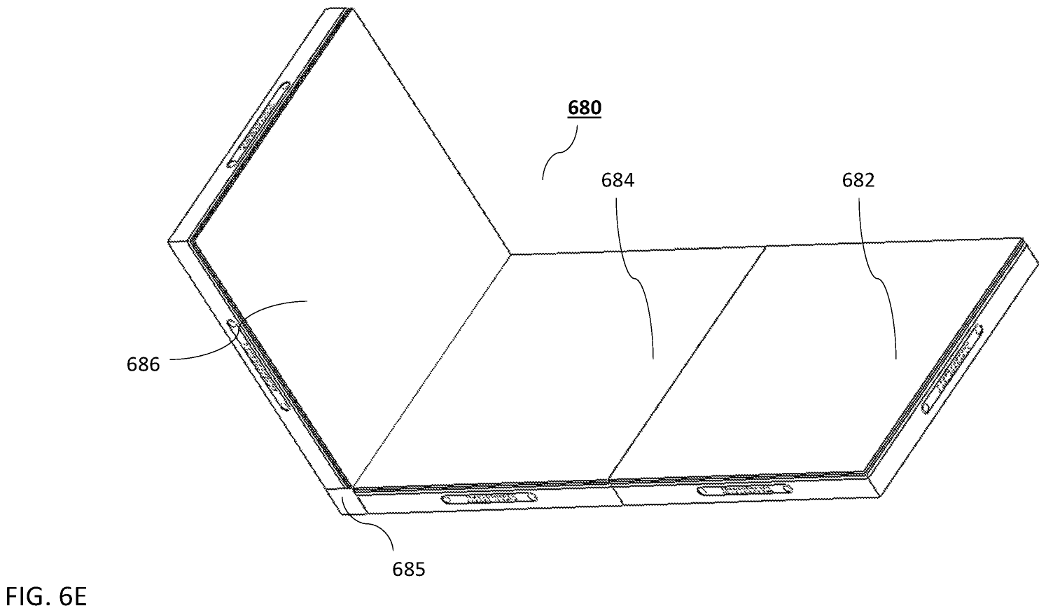

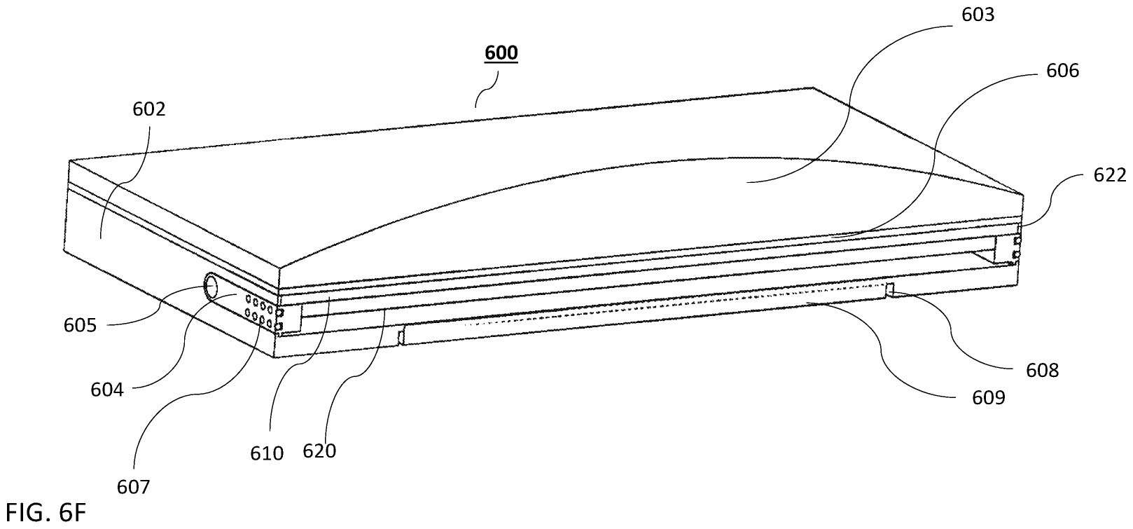

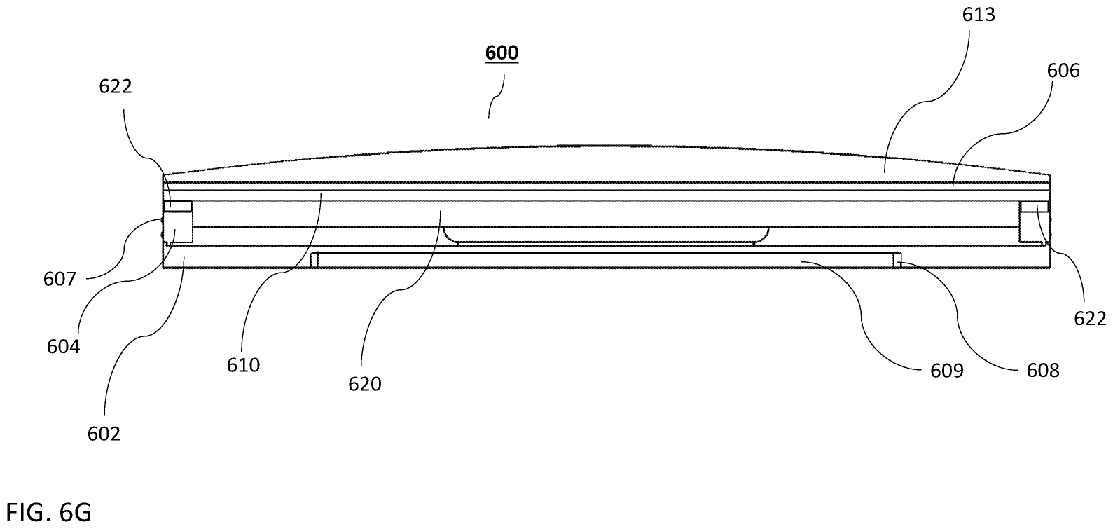

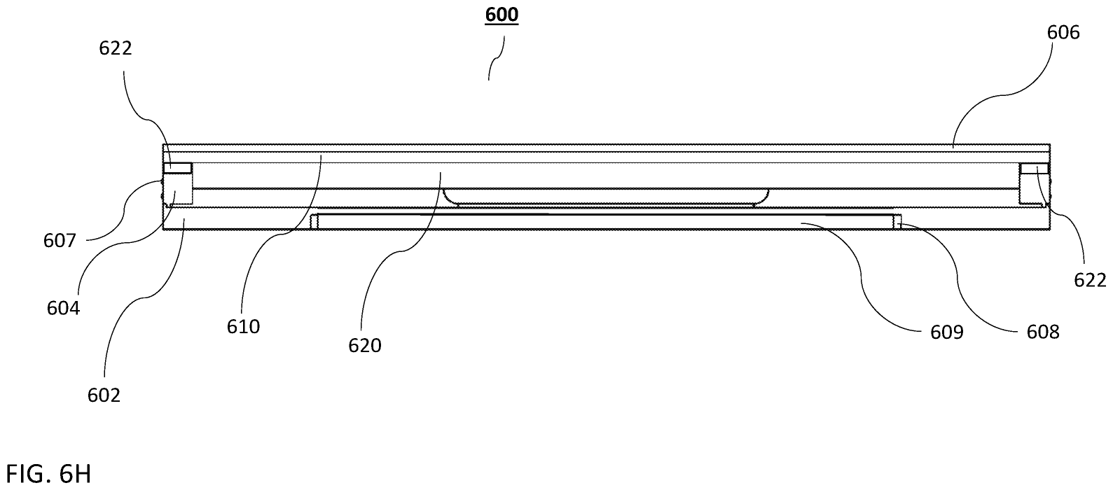

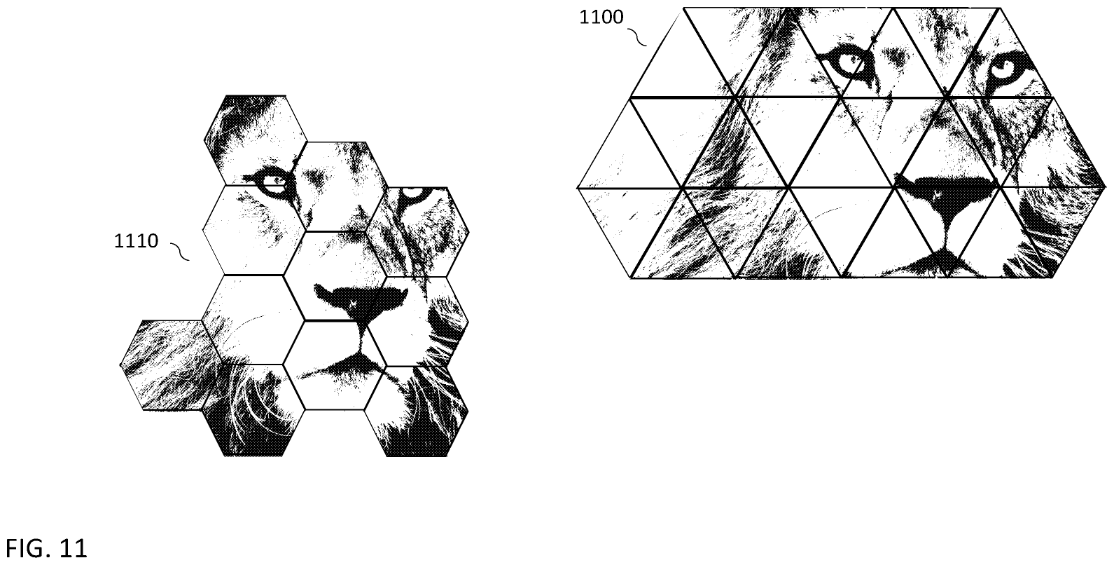

In some embodiments, display tiles in tile array 120, such as, for example, display tile 122, may be connected to each other via connectors 604 located on four sides of each such tile (see for example FIG. 6A). Such connectors may transfer electrical power, data, control and/or other electrical signals between different display tiles in tile array 120. Such connectors 604 may include permanent magnets 605 to firmly hold neighboring display tiles together. In other embodiments, such connectors 604 may include mechanical means to firmly hold neighboring display tiles together (such as, for example, pins, sockets, screws, hooks, glue, rubber bands, strings, springs, etc.). In some embodiments, at least some display tiles in tile array 120, for example, display tile 122, may be touch sensitive and have touch-screen capabilities. For example, they may be able to sense the position and type of gesture of users touching the display (for example, by incorporating standard touch-display technology into the display tile, see for example U.S. Pat. No. 8,243,027B2). In some embodiments, information related to the touch such as, for example, the position and type of gesture, may also be transferred via display tile connectors 604 (e.g. to other/neighboring display tiles that are part of tile array 120, or to MPU 101). In some embodiments, connectors 604 may include conductive pins array 607 that transfer electrical signals. In some embodiments, pins in conductive pins array 607 are magnetic self-mating connectors that may be attracted by a magnetic force to the correct position. In some embodiments, display tiles such as display tile 122 may be symmetric with respect to all of their sides (e.g. in all 4 sides of a square, all 3 sides of a triangle etc.), and each tile can be mounted and connected to other display tiles in any orientation. In some embodiments, display tiles such as display tile 122 may be square, and may be connected to neighboring display tiles at any of 4 possible orientations (i.e. 0 degrees, 90 degrees, 180 degrees or 270 degrees rotation with respect to neighboring display tiles). In some embodiments, display tiles such as such as display tile 122 may have other shapes (e.g. triangular, rectangular, hexagonal, see for example FIG. 11) and may be connected to neighboring tiles at any possible orientation. Display tiles in tile array 120 may differ in size and shape from each other. In an embodiment, display tiles such as display tile 122 in tile array 120 are mounted and connected to other tiles in one or more specific orientations. In some embodiments, display tiles such as display tile 122 may include an orientation sensor (e.g. an accelerometer, not shown), which allows self-determination of the right orientation relative to earth's gravity. In some cases, neighboring display tiles may report to each other their respective orientation. In some cases, the orientation of a display tile may be reported back to or from MPU 101 (see below).

In some embodiments, MPU 101 may be connected to tile array 120. MPU 101 may be mounted on wall 150 and connected to display tile array 120 directly. In some embodiments, MPU 101 may be connected to display tile array 120 via a dedicated cable 104 and a connector 106. Dedicated cable 104 may transfer power, and/or data, and/or control and/or other electrical signals from MPU 101 to tile array 120. Connector 106 may connect to any display tile of tile array 120, and for any side of a tile 122 that is not connected to a neighboring tile 122. Connector 106 may have the same (or substantially the same) interface as that of a display tile connector 604. In an embodiment, it may connect to a display tile magnetically (e.g. using permanent magnets).

In some embodiments, MPU 101 may have the shape and size of a display tile, or of several display tiles placed together one next to each other (for example, it may have the size of 2 display tiles, 3 display tiles, 4 display tiles, etc., in any configuration, such as a 1×2 configuration, 2×2 configuration, etc.). MPU 101 may be mounted on wall 150 in the same manner as tile array 120. In some embodiments, MPU 101 may be mounted on top of an electrical power socket, covering it, and it may be connected to such power socket using a cable or electrical that extends from the back side of MPU 101 (facing wall 150), so that MPU 101's connection to electrical power socket is hidden from an observer facing it.

In some embodiments, MPU 101 may control the content displayed on tile array 120. In some embodiments, MPU 101 may synchronize image information displayed over tile array 120 and control the rate at which data is refreshed by display tiles in tile array 120. In some embodiments, MPU 101 may serve as an interface to external devices, such as, for example, streaming devices, mobile devices, computers and other devices that typically connect to displays (referred to hereafter as “content devices”), either via wire or wirelessly, to display content. In some embodiments, MPU 101 may include a connector interface 102. Connector interface 102 may include standard wired communication sockets such as, for example, High-Definition Multimedia Interface (HDMI) ports, Digital Visual Interface (DVI) ports, USB ports, mini-USB ports, USB-C ports, DisplayPort ports, Mobile Industry Processor Interface Display Serial Interface (MIPI DSI), Lightning ports, etc., for connecting content devices to MPU 101. In some embodiments, connector interface 102 may include a wireless interface, such as, for example Wi-Fi, Bluetooth, cellular, ZigBee, etc., over which content devices may connect to MPU 101. In some embodiments, connector interface 102 may include standard ports for connecting audio devices, for example, speakers, headphones, receivers, amplifiers, etc. These ports may include, for example, RCA jacks, 3.5 mm stereo audio jacks, S/PDIF jacks, IEEE 1394 “firewire” jacks, XLR connectors, etc. In an embodiment, connector interface 102 may include a standard wireless interface for transmitting audio such as Wi-Fi, Bluetooth, etc. In some embodiments, MPU 101 may connect to a power outlet 142 via a power cable 108.

In some embodiments, MPU 101 may include a light indicator 110, such as a LED lamp, which may be used by MPU 101 to emit light in different colors, different illuminations and/or different intensities to indicate to users a status of MDS 100. For example, if no display tiles are connected to MPU 101, light indicator 110 may show a red light, or if the system is functioning well, light indicator 110 may show a white light, etc.

FIG. 1B illustrates the usage of MDS 100. In some embodiments, one or more content devices may be connected to MPU 101. As an example, a laptop computer 162 may be connected to MPU 101 via wired connection to a port 103 in connector interface 102. A streamer 164 may be connected via a wired connection to MPU 101 via a port 105 in connector interface 102, and a mobile device 160 may be connected to MPU 101 via a wireless interface of connector interface 102. Content devices connected to MPU 101 may stream content concurrently.

In some embodiments, audio devices such as speakers 170, headphones 172 and others may be connected to connector interface 102. In this example, speakers 170 are connected via a wired connection to connector interface 102 and headphones 172 are connected wirelessly to connector interface 102 (other combinations are of course supported). MPU 101 may decide how to route incoming audio signals from connected content devices to connected audio devices, based on, for example, a displayed size of corresponding output stream, a user input, etc. In other embodiments, MPU 101 may send audio data to tile array 120, to be played back by display tiles with audio playback capabilities.

In some embodiments, MPU 101 controls how content from different content devices is displayed over tile array 120. Decisions regarding how to display content may take into account various factors such as, for example, the number of display tiles 122 in tile array 120; the resolution of display tiles 122 in tile array 120; the spatial configuration of tile array 120; the resolutions and frame rates of streamed content from content devices; user choices and configuration; the display configuration of already displayed content; the displayed content itself; the type and parameters of the connected content devices, etc.

In some embodiments, users may interact with MDS 100 and control its configuration. For example, a user 130 may interact with MDS 100 via an application installed on mobile device 160. In an embodiment, user 130 may interact with MDS 100 via a remote control 166. In an embodiment, a user 132 may interact with MDS 100 by giving voice commands that are received, deciphered and executed by MPU 101. In an embodiment, a user 134 may interact with MDS 100 using touch gestures on touch-sensitive display tiles 122 in tile array 120.

In some embodiments, interaction between users and MDS 100 may include the ability of users to control various aspects of how content is displayed on tile array 120. For example, users may be able to do any combination of the following: control picture quality features (such as brightness, sharpness, contrast, color hue, color temperature, color saturation, displayed color space, black level, etc.) of part of the displayed stream of frames or the entire displayed stream of frames; to control the position of each part of the displayed stream of frames on tile array 120; to control the size of each part of the displayed stream of frames on tile array 120; to control the rate of each part of the displayed stream of frames on tile array 120; to control the sound and/or audio that is associated with each part of stream of frames displayed on tile array 120 (including controlling volume, pitch, associating audio devices with different audio channels, etc.); to scrub each part of the displayed stream of frames—backwards or forwards at a certain speed; to control how different parts of the displayed stream of frames are blended together; to control background content that may be displayed in areas over tile array 120 where content from content devices is not displayed, etc., and in general control different aspects of content that is displayed on tile array 120. In some embodiments, MPU 101 may pass information to users (such as users 130, 132 and/or 134) about the status of MDS 100 in various ways, for example, via messages and/or alerts on a mobile/PC application, via displaying information on tile array 120, via playing different audio sounds or messages, etc.

In some embodiments, the interaction between users (such as users 130, 132 and/or 134) and MDS 100 may include changing the spatial arrangement of display tiles in tile array 120, for example by disconnecting display tiles from neighboring display tiles in tile array 120, or by connecting display tiles to existing display tiles in tile array 120, and by that modifying the size and shape of tile array 120. In an embodiment, such modification of shape and size to tile array 120 may be done when the display is not actively streaming or when it is turned off. In another embodiment, such modification of shape and size to tile array 120 may be done when the display is actively streaming. In such case, MPU 101 may adjust the way content is displayed over tile array 120 during active streaming (for example, it may decide to shift position, resize or change other properties of parts of the displayed stream of frames) to account for its modified spatial configuration.

In some embodiments, MDS 100 may display several streams concurrently over tile array 120, each stream spanning only part of tile array 120. Several viewers may each view and interact with only a part of tile array 120, concurrently. For example, user 134 may view a stream that is displayed only on sub-array 126, and user 132 may view a stream that is displayed only sub-array 124.

Tile array 120 may consist of different types of display tiles. For example, some display tiles may have display capabilities, some display tiles may have touch-screen capabilities in addition to display capabilities, some tiles may have no display capabilities at all, some tiles may have only audio playback capabilities, some display tiles may have audio playback capabilities in addition to display capabilities, and some display tiles may have display capabilities, audio playback capabilities and touch-screen capabilities, altogether.

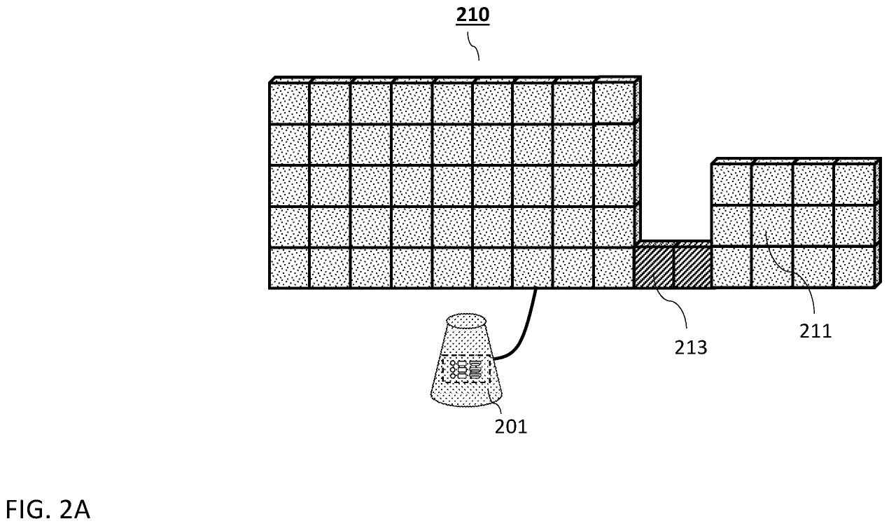

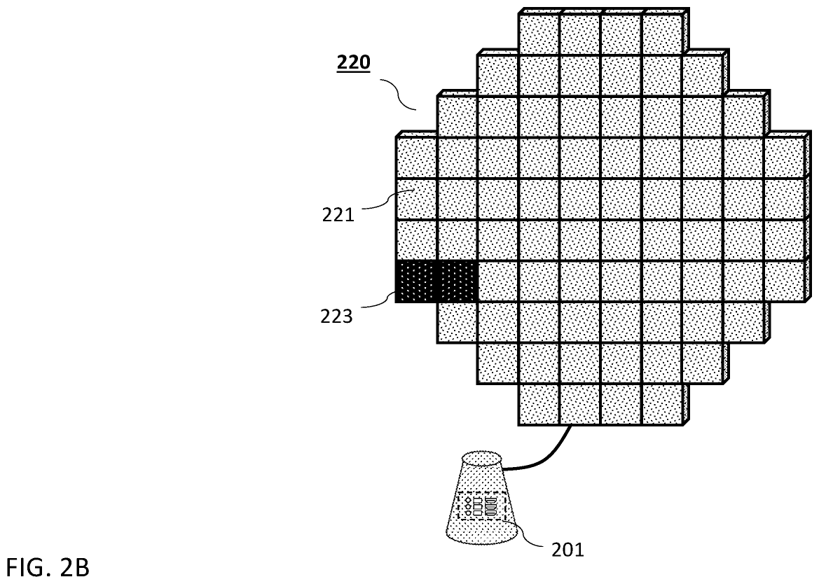

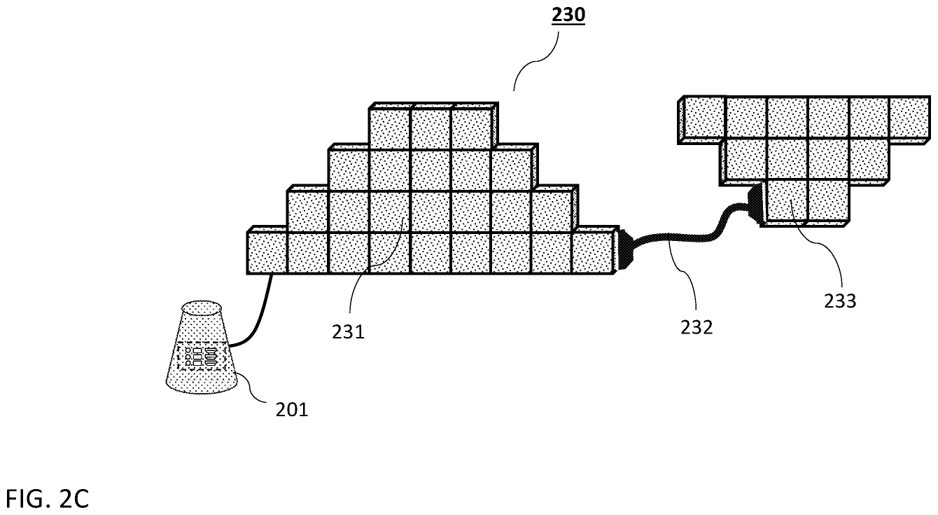

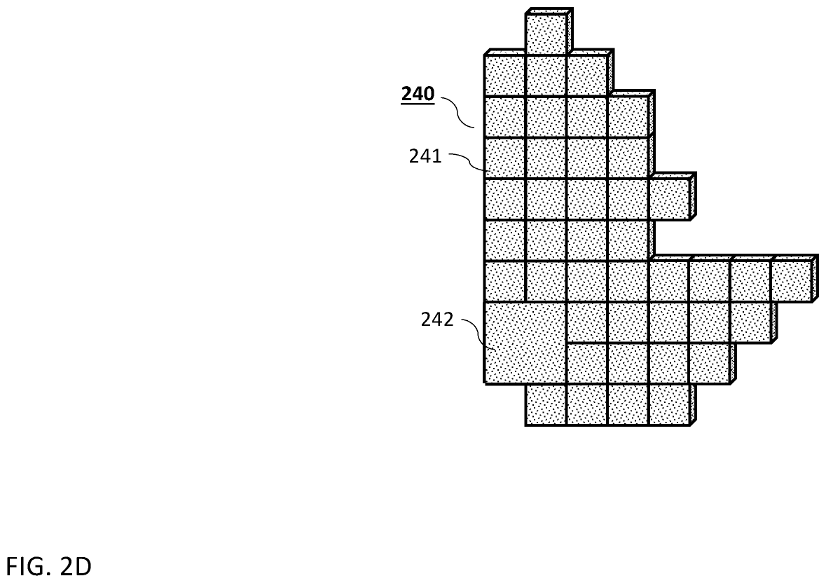

FIG. 2A shows an illustrative configuration of a display tiles array, numbered 210. Tile array 210 includes two types of display tiles: display tiles such as a display tile 211, marked by black dots on white background, which have display capabilities, and display tiles such as a display tile 213, marked by black and white diagonal stripes, which do not have display capabilities. In this configuration, the display tiles in tile array 210 create two displays, one larger and one smaller, which are connected by two tiles which do not display any image information (but can still relay power, data and control information from MPU 201 to all display tiles).

FIG. 2B shows another illustrative configuration of a display tiles array, numbered 220. Tile array 220, also includes two types of display tiles—display tiles such as a display tile 221, marked by black dots on white background, which have display capabilities, and display tiles such as a display tile 223, marked by white dots on black background, which have display capabilities and are also touch-sensitive, with touch-screen capabilities. In this configuration, the display tiles in tile array 220 allow for user interaction with the display through touch-based interface on a couple of display tiles.

FIG. 2C shows yet another illustrative configuration of a display tiles array, numbered 230. Tile array 230 may also include two parts, display tiles 231 and display tiles 233, connected between them by a cable 232 that transfers information between them.

In some embodiments, display tiles with touch capabilities may show a distinctive marking to viewers to help distinguishes them from display tiles with no touch capabilities and help identify them in the display tiles array. In an embodiment, such distinctive markings may include, for example, a distinctive frame that is displayed around the content displayed over the touch-sensitive display tile. In an embodiment, such distinctive markings may include for example displaying at least part of the pixel content of the touch-sensitive display tile with a different signal level (i.e. brightness) or a different hue compared with intended signal level or hue. In another embodiment, such distinctive markings may include for example a tile with touch-display capabilities having a different shape or a different mechanical structure or a different color that distinguishes it from tiles with no touch-display capability. In another embodiment, such distinctive markings may include for example displaying over the tile (e.g. an overlay icon in the corner of the tile) some distinguishing data (e.g. an icon of a hand for a touch-display type, an icon of a speaker for a speaker integrated display tile, an icon of a camera for a camera integrated tile, etc.).

FIG. 2D shows another illustrative configuration of a display tiles array. In FIG. 2D, a tile array 240 includes one type of display tiles, such as a display tile 241, marked by black dots on white background, which have display capabilities. In this configuration, MPU 242 is part of tile array 240, and is able to display content. In this illustrative embodiment, MPU 242 is implemented as a larger display tile, twice larger than display tiles such as display tile 241 in width and height, but with the same thickness as display tile 241. In some embodiments, MPU 242 may also have touch capabilities. In some embodiments, MPU 242 may show some distinctive marks indicating to the user that it is an MPU tile. In some embodiments, MPU 242 may have external connectors in addition to connectors that allow it to connect to display tiles in tile array 240. In some embodiments, MPU 242 may have the same width and height as display tile 241.

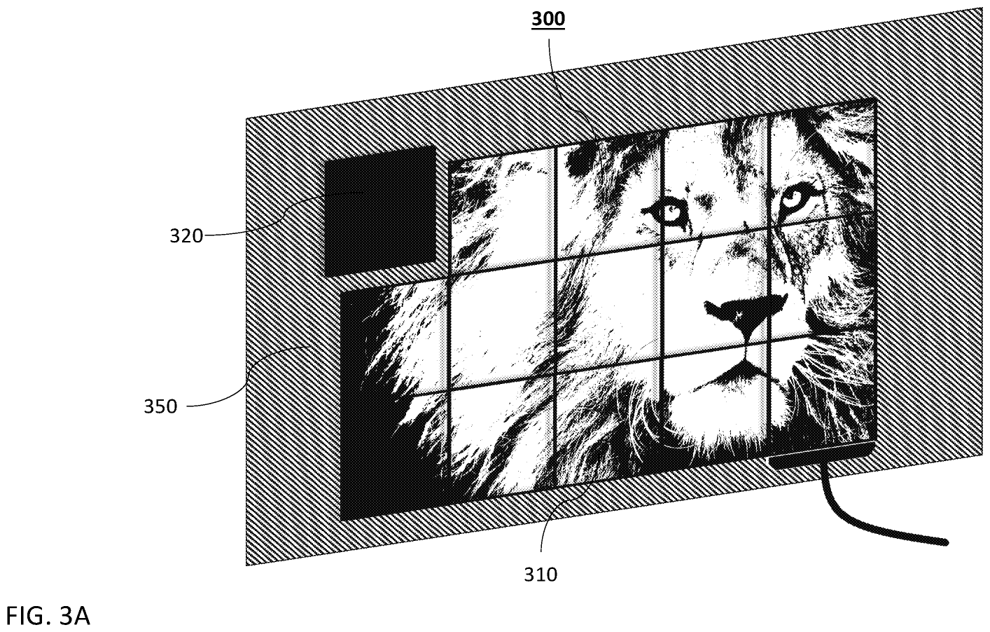

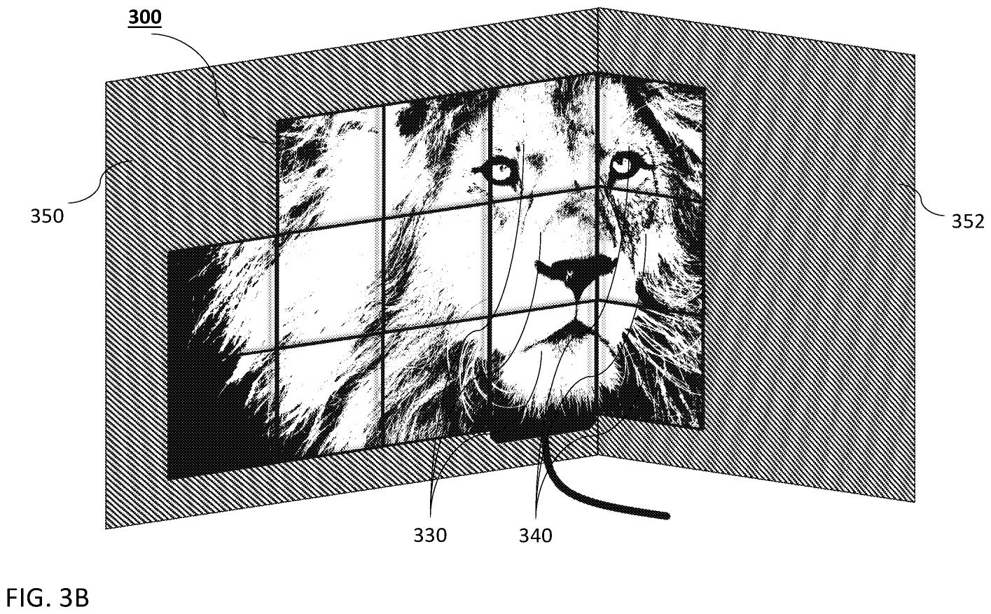

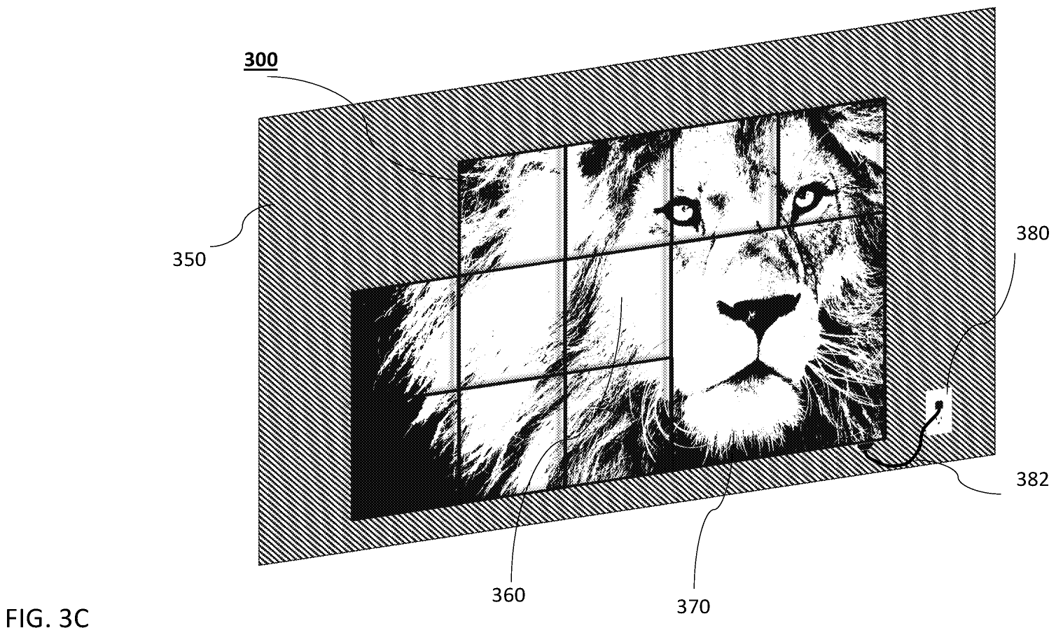

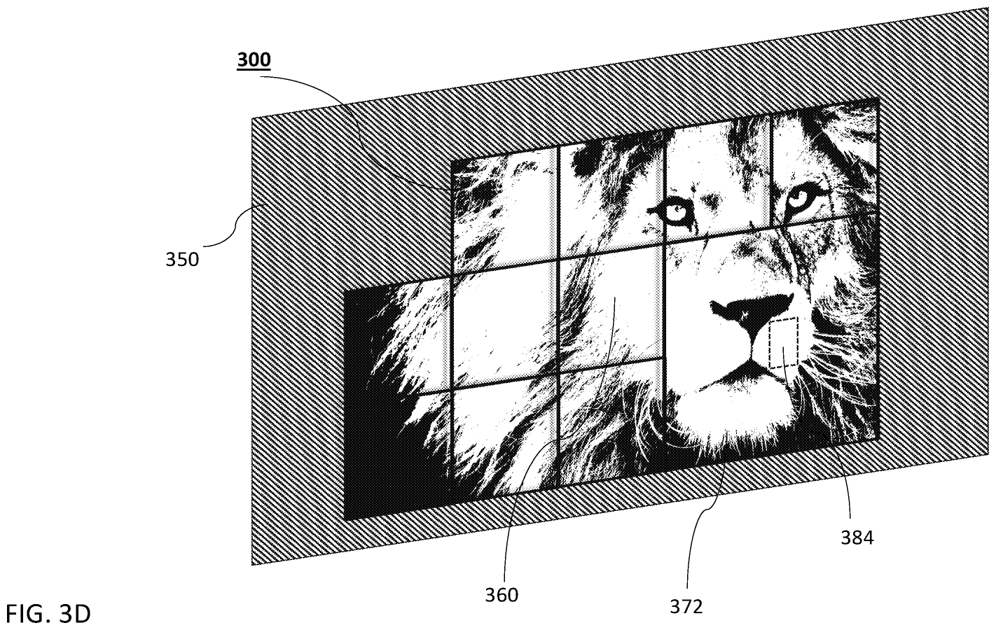

FIG. 3A shows an illustration of a tile array 300 in operation. In an embodiment, tile array 300 may be mounted (e.g., magnetically) on layer 350. Display tiles 310 may display an image such that image support spans the entire array of tiles, including a missing display tile 320 that is not yet connected to tile array 300 (this part of the image data may not be displayed, but the proportions and aspect ratio of displayed data on connected display tiles 310 may match an image support that includes the area missing display tile 320 should occupy). The black lines separating tiles are drawn only for the purpose of marking the borders between tiles.

FIG. 3B shows an illustration of tile array 300 mounted on two walls 350 and 352, perpendicular to each other. In some embodiments, display tiles 330, which are mounted on wall 350 may be connected to display tiles 340 which are mounted on wall 352 via a connector that is attached to and enables 90-degrees connection. Refer to FIG. 6D and to its description as an example for such a connector. Other types and/or shapes of connectors are possible, such as flexible connectors, L-shaped connectors, etc. In other embodiments, either display tiles 330 or display tiles 340 may have extensions on their sides that enable other display tiles to connect to them at 90-degrees angle. Refer to FIG. 6D and its description for an example for such a display tile with extension. Refer also to FIG. 6E for example for a tile array including connected co-planar display tiles and connected perpendicular display tile.

FIG. 3C shows an illustration of tile array 300 mounted on wall 350. In some embodiments, as shown in FIG. 3C, MPU 370 may be implemented as an integral part of tile array 300, and act as a display tile (possibly with touch capabilities) in addition to its role as an MPU of the MDS. MPU tile 370 may be mounted on wall 350 and connected to display tiles 360, e.g. using standard connectors. Exemplary, MPU tile 370 width and height are twice the width and height of each of display tiles 360 (however, MPU tile 370 may have different width and height, including the same width and height as display tiles 360). MPU 370 may be connected to electrical socket 380 by means of electrical cable 382 to supply power to MPU 370 and to tile array 300. FIG. 3D shows an illustration of tile array 300 mounted on ferromagnetic layer 350, as in FIG. 3C. In some illustrative embodiments, as shown in FIG. 3D, MPU tile 372 may be mounted on top of electrical socket 384, which is hidden by MPU tile 372 in FIG. 3D and marked by a dashed line. MPU tile 372 may be connected to electrical socket 384 by a connector protruding from MPU tile 372's back side (the side which faces ferromagnetic layer 350).

### MPU Structure

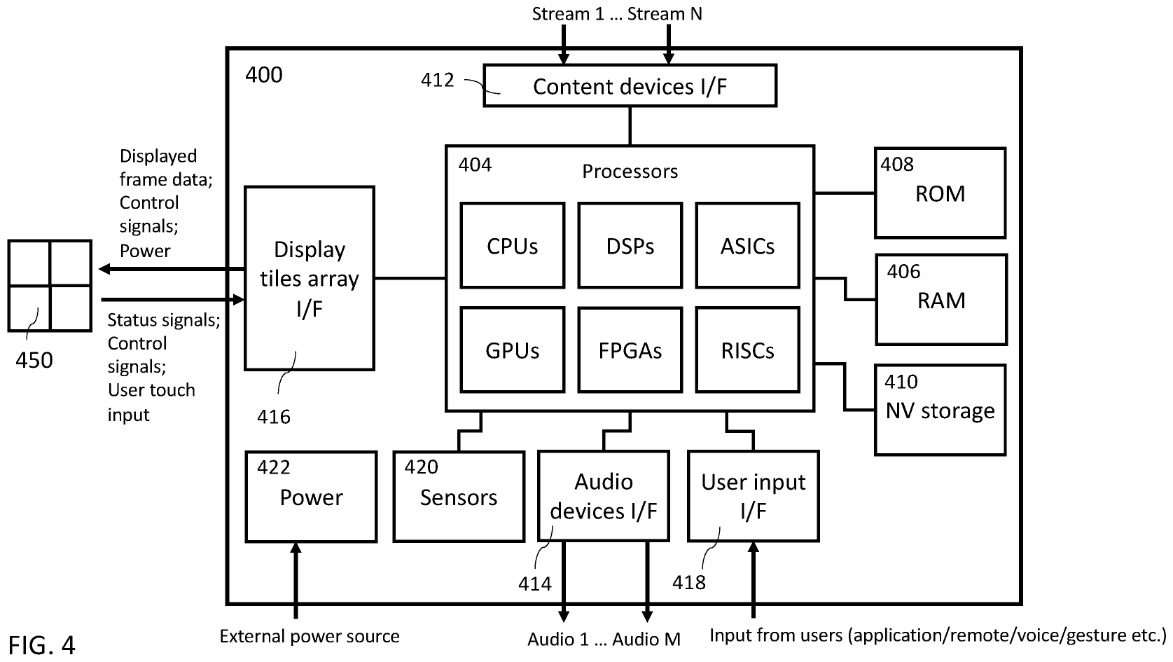

FIG. 4 shows a block diagram of a MPU 400 (an example embodiment of MPU 101), with the different components it may include. In some embodiments, MPU 400 may comprise processors 404, a content devices interface 412, a tile array interface 416, a random access memory (RAM) module 406, a read only memory (ROM) module 408, a non-volatile memory (NVM) module 410, a user input (UI) interface 418, an audio device interface 414, a sensors module 420 and a power module 422. In some embodiments, some of aforementioned modules and/or interfaces may be arranged differently, for example, some may be combined into one module or interface. In some embodiments, not all modules may be present, such as, for example, ROM module 408 or sensor module 420. In some embodiments, MPU 400 may also include a system bus (not shown in FIG. 4), to which aforementioned modules may be connected. In some embodiments, processors 404 may consist of several types of processing units, including but not limited to: central processing units (CPUs), graphic processing units (GPUs), digital signal processors (DSPs), field-programmable gate arrays (FPGAs), reduced instruction set computers (RISCs), application specific integrated circuits (ASICs) and/or any combination thereof. In an embodiment, RAM module 406 may include random-access memory for storing data and instructions required for the operation of MPU 400. In an embodiment, ROM unit 408 may include PROM, EPROM and/or EEPROM and/or other type of read-only memory. In an embodiment, NVM module 410 may include solid-state non-transitory storage media, such as, for example, Flash memory. Various memory blocks (e.g. modules 408, 410) may be used to store any kind of data, such as, for example, system parameters, user preferences, device profile, program instructions, program data, files, etc. In some embodiments, content devices interface 412 may comprise hardware, connectors and interface hardware (such as, for example, different ports, wired and wireless communication buses, antenna arrays, electrical components, etc.) required for connecting content devices. Such hardware and interface hardware may include implementation of known standards for transmitting video/audio such as, for example, HDMI, DVI, DisplayPort, MIPI DSI, may include wireless communication hardware such as WiFi, 3G, 4G and 5G, Bluetooth, for wirelessly transmitting information, wired communication channels such as USB, USB-C, etc. In some embodiments, tile array interface 416 may support two-way communication between MPU 400 and tile array 450. Communication interface 416 may include some of the connectors and interface hardware as described above for interface 412, including HDMI, DVI, DisplayPort, MIPI DSI, USB, USB-C, 3G, 4G, 5G, WiFi etc. or other dedicated wireless communication hardware, and/or dedicated wired connectors meant for high-throughput transfer of frame data and/or control, and in addition, interfaces and hardware for transferring low throughput data such as control information, for example I2C, USB, USB-C, SPI, DisplayPort control channels, MIPI DSI control channels, HDMI control channels, etc., and/or dedicated connectors meant for control and/or user input. In some embodiments, communication interface 416 may include the capability to wirelessly communicate (i.e. send and/or receive data and control signals) with multiple display tiles concurrently (i.e. at about the same time window, or during overlapping time windows)—preferably, the ability to communicate with more than 1 display tile concurrently, more preferably to communicate with more than 20 display tiles concurrently, and even more preferably, to communicate with more than 100 display tiles concurrently. Such concurrent communication may be realized by common methods, for example, allocating different frequency bands to each dedicated communication channel between MPU 400 and one display tile from tile array 450, as is the case in frequency-division-multiple-access (FDMA) communication methods; using a different orthogonal code for each dedicated communication channel between MPU 400 and one display tile from tile array 450, as is the case, for example, in code-division-multiple-access (CDMA) communication methods. It is worth noting that the close physical proximity between display tiles 450 and MPU 400 supports effective and high-throughput short-range wireless communication.

Communication between MPU 400 and tile array 450 may include, for example, displayed frame data for display tiles that are part of tile array 450, audio data (such audio data may be played-back by display tiles with audio playback capability), control messages for updating parameters stored in display tiles, gesture information from users on touch-sensitive display tiles in tile array 450, etc. In an embodiment, audio devices interface 414 may include interfaces and ports for connecting different audio devices, such as, for example, speakers, headphones, receivers, amplifiers, etc. In an embodiment, user input interface 418 may include various interfaces and hardware components required for receiving user input, such as WiFi, Bluetooth (both may be used, for example, for connecting to an application running on a mobile device or PC, or to a remote control unit, or similar device), IR (which may be used for connecting to a remote control unit), microphone (which may be used for receiving voice commands from users), camera and/or depth camera (which may be used for detecting control gestures of users), keyboard, mouse, etc., or any combination thereof. In some embodiments, sensors module 420 may include sensors such as motion detection sensor, accelerometers, gyroscopes, microphones, cameras, ambient light sensor, temperature sensors, moisture sensors, magnetic field sensors, etc., that may be used to obtain information about the environment in which MPU 400 is located (for example, such information may include the presence of people in vicinity, amount of light, the ambient temperature, spoken voice commands, hand gestures made, etc.). Such information may be used to control and influence the content displayed on tile array 450, connected to MPU 400, and on audio played by devices connected to MPU 400 (for example, such influence may include changing of colors, increasing/decreasing brightness, increasing/decreasing audio volume, resizing displayed image, modifying system parameters, etc.).

In some embodiments, different modules of MPU 400, such as interfaces 412, 414, 416, 418, sensors module 420 and others may be implemented in hardware, such as ASIC, or in software, that may run on a processing unit such as, for example, a central processing unit (CPU) and/or a (GPU) and/or a field-programmable gate array (FPGA) and/or a digital signal processor (DSP) and/or reduced instruction set computer (RISC). In an embodiment, a combination of hardware (ASIC) and software running on processing units may be used to implement said modules.

In some embodiments, MPU 400 includes power module 422 that may receive power from an external power source. Power module 422 may be required to provide power to different modules of MPU 400 (connections not shown in FIG. 4) to support their operation, and also to tile array 450 (through tile array interface 416).

### MPU Functionality

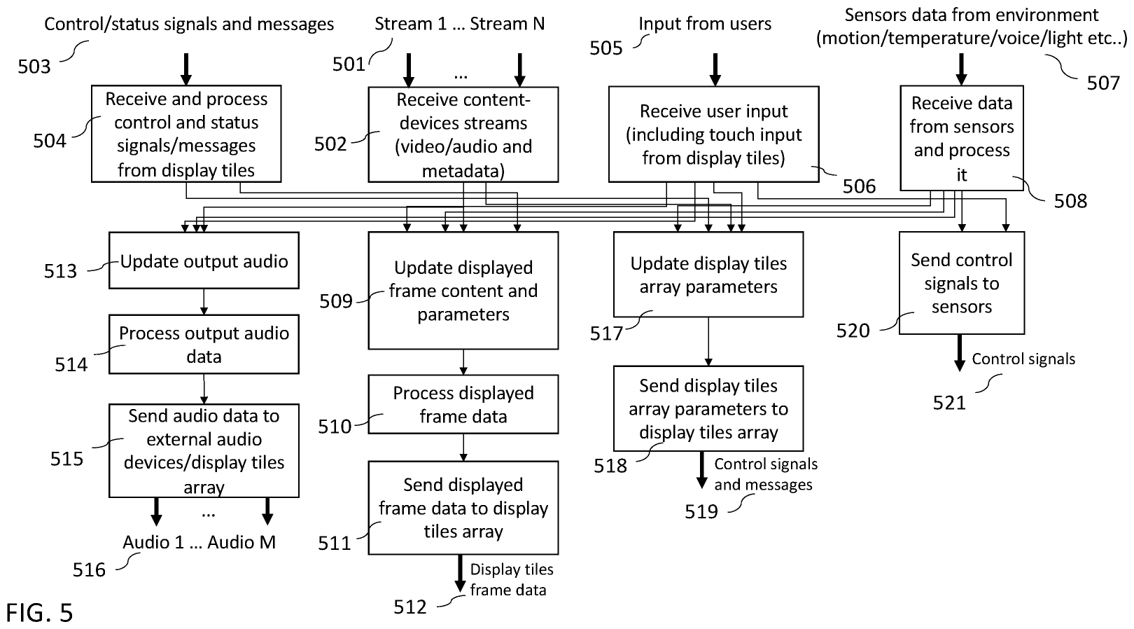

MPU 400 functionality may include receiving input streams from various content devices (each of which may include a still image, video, audio or a combination thereof), processing the incoming data, constructing a frame from the different streams and displaying it on connected tile array 450, directing audio to external devices (and/or also to tile array 450), and responding to user interactions (that may occur in various formats), by modifying properties of the displayed frame, played audio, etc., and indicating to users about the status of MDS 100. Other functionalities may also be supported by MPU 400. Exemplary, FIG. 5 shows a flow diagram describing some functional operations of MPU 400 that may be performed by MPU 400 at different stages of its operation. Such functional operations may be implemented by SW instructions, by HW logic or state-machine and/or a combination thereof.

In some embodiments, MPU 400 may receive several types of inputs that may influence its operation. In some embodiments, during operation, in step 502, MPU 400 may receive as an input up to N streams 501 (N may be, for example, 1, 2, 10, 50,128, 500, in the range of 1 to 1000, or even above 1000, etc.) each of which may contain input video frames or images, audio data, metadata or a combination thereof, from content devices that may be connected to it (via a wired connection or wirelessly). MPU 400 may receive input streams 501 through content devices interface 412. Streams 501 input to content devices interface 412 need not be synchronized and may have different resolutions, different frame rates and/or different formats, may have audio data or no audio data, may be still images that do not change over time, etc. In some embodiments, during operation, in step 504 MPU 400 may receive control and status signals and/or messages 503 from display tiles in connected tile array 450. In step 504, MPU 400 may also process signals/messages 503 (for example, such processing may include parsing messages, extracting information from signals and messages, etc.). In some embodiments, during operation, in step 506 MPU 400 may receive inputs from users 505 (via module 418). Such input may include altering system configuration, controlling displayed image content and properties and audio playback content and properties. In some embodiments, user input may be given through touch gestures over touch-sensitive display tiles, voice commands, visual gestures (recognized through a camera and/or depth camera), software applications (e.g. mobile applications or computer software), keyboard and/or mouse, remote control, etc. In some embodiments, during operation, in step 508 MPU 400 may receive sensors data from environment 507, collected by sensors 420. Such data may include information about the environment in which MPU 400 is located, such as the presence of motion, the ambient temperature, level of moisture in the environment, magnetic field orientation, ambient light intensity and color, sounds and voices, etc. In some embodiments, in step 508 sensors data may also be processed, for example to remove noise, to detect changes in collected data (e.g. a rise in temperature, sudden motion, change in light intensity and/or color, change in humidity, etc.), etc.

In some embodiments, different inputs received by MPU 400 during operation may affect how MPU 400 updates displayed frame content and parameters. In step 509, input data from steps 502, 504, 506, 508 (or any combination thereof) may be sent to processors 404 and used to update displayed frame content and parameters. In step 509, MPU 400 determines how input content from different content devices is displayed on tile array 450. Several factors may affect this decision, such as, for example, parameters of input streams 501 (for example, resolution, frame rate, number of streams, content of each stream, etc.), user input 505 (for example, users may decide to direct a certain input stream to a certain region in tile array 450, to modify frame rate, colors or brightness, size of displayed stream, etc.), parameters of display tiles in connected tile array 450, which may be received through messages 503, such as, for example, their resolution, spatial arrangement, number of tiles, etc. (for example, a tile array with small number of tiles may reduce the number of input streams that may be present in displayed frames; these parameters may also affect the arrangement of input streams frames in the final displayed frame, the size of each input content, how they are blended together, etc.), data about the environment 508 (for example, the presence of motion may activate some parts of tile array 450, a change in ambient light may affect the brightness and/or color of displayed frame, etc.). In some embodiments, in step 509, processors 404 may also process the frames received in streams 1 to N 501, applying, for example, frame cropping, frame scaling, frame binning, frame subsampling, geometric transformation such as rotations, translations, skew, projections, distortion, frame color transformations (for example, modifying hue, intensity and color saturation) and/or format transformations (for example, from RGB to YUV) to each of the input frames. Display rate transformations may also be applied to the incoming streams of frames 1 to N 501. In some embodiments, such transformations may change in time, based on several factors such as user input 505, number of incoming streams 501, connected tile array parameters, received through control/status signals and messages 503 (for example, number of tiles, their resolution, spatial arrangement, etc.), etc. In some embodiments, processors 404 may also blend between input frames from different input streams and between input frames and some predetermined background frame (which, for example, may be chosen according to user input 505, input frames content of frames in streams 501, connected tile array parameters that are received through signals and messages 503, etc.). Such blending may be done using spatially varying alpha-blending, that changes, for example, according to position of the displayed frame on connected display tile array 450, according to user input 505, according to input frames parameters in streams 501, etc. In some embodiments, processors 404 may synchronize input frames from input streams 1 to N 501. In an embodiment, in step 509, processors 404 may generate a displayed frame, with size and resolution according to number of display tiles in connected tile array 450, their resolution and spatial arrangement, and according to user input 505, by combining substantially all or part of incoming input frames from input streams 1 to N 501, into one combined frame that is intended to be displayed over connected tile array 450. In an embodiment, such combination may be done before, or after processing and blending all or part of input frames from input streams 1 to N 501. In some embodiments, processors 404 may divide said one combined frame to data that is displayed over each display tile in connected tile array 450 and may send this data to display tiles through tile array 450 interface 416, to be displayed. In some embodiments, after step 509, in step 510, processors 404 may apply further processing to displayed frame data (which, in turn, may also be affected by data supplied to step 509). In step 511, MPU 400 sends display tiles frame data 512 to tile array 450 (through tile array interface 416, either via wired interface or wirelessly) for it to be displayed.

In some embodiments, different inputs received by MPU 400 during operation may affect how MPU 400 updates audio that is output to external audio devices and/or to display tiles array. In step 513, input audio data included in at least part of input streams 1 to N 501 and received in step 502 may be sent to processors 404, together with input data received in steps 506, 508 (or any combination thereof) and used to update audio output. In step 513, updating output audio may include different adjustments to input audio data, such as modifying the volume, pitch, rate and/or applying digital filtering or signal processing, etc., according to different factors, such as user input 505 (for example, users may decide to increase/decrease audio volume), according to the level of voices (for example, processors 404 may decide to reduce audio volume if voices are heard), light and presence of motion in the vicinity of MPU 400 (as measured in sensors data 507), etc. After audio output is determined, in step 514, some processing may be applied on audio data (which, in turn, may also be affected by data supplied to step 513), and in step 515, MPU 400 may direct at least part of processed audio data from step 514 to 1 to M external audio devices 516 (M, for example, may be 128), through audio devices interface 414. The way processed audio data is directed to 1 to M audio devices 516 in step 515 may be determined affected by user input 505, sensors data 507, etc. (for example, users may decide to direct one audio channel to an external speaker connected to MPU 400 through audio devices interface 414, and another audio channel to external headphones connected to MPU 400 through audio devices interface 414).

In some embodiments, different inputs received by MPU 400 during operation may affect how MPU 400 updates parameters and configuration of tile array 450. In step 517, input from users 505, received in step 506, together with control/status signals and messages 503, stream 1 to N 501 (including their metadata), and sensors data 507, received in steps 504, 502 and 507 respectively, are used to update tile array 450 parameters and configuration, such as, for example, updating routing tables for relaying messages and information between display tiles, determining which display tiles may be active and which display tiles may be inactive, etc. For example, users may decide to use only a small part of tile array 450, in which case, MPU 400 may decide to turn off or to put on standby some of display tiles in tile array 450. As another example, users may remove or rearrange some display tiles from tile array 450, in which case a message may arrive to MPU 400 as part of control/status signals and messages 503, and in step 517, MPU 400 may decide to update some of the routing tables in some display tiles of tile array 450, to account for the new arrangement of display tiles (see further explanation about data routing within tile array 450 in section “Modes of operation and communication between MPU and display tiles array”). The update process may be performed using processors 404. After tile array 450 parameters and configuration has been updated in step 517, in step 518, MPU 400 may send the updated parameters and configuration to display tiles in tile array 450, via control signals and messages 519.

In some embodiments, MPU 400 may also send control signals or messages to various sensors in sensors module 420, to control their operation. In step 520, after sensors data from environment 507 is received and processed in step 508, together with input from users 505, received in step 506, MPU 400 may send control signals 521 to sensors 420. For example, such control signals may activate sensors (e.g., users may touch touch-sensitive display tiles in tile array 450 to modify displayed frame parameters, and such user input may trigger the activation of ambient light sensor to measure the ambient light color temperature, which in turn may affect how displayed frame parameters are modified), may modify parameters of sensors (e.g. sensitivity, rate of operation, etc.).

In some embodiments, irrespective of inputs 501, 503, 505, 507, processors 404 may execute control instructions necessary for the operation of MPU 400, such as control instructions for operating and controlling modules within MPU 400 (e.g. modules 408, 406, 410, 420, 422) and/or different processing units in processors 404, and also control data arriving from interfaces in MPU 400 (e.g. interfaces 412, 414, 416, 418, and/or sensors 420).

### Display Tiles Structure

In this section, non-limiting examples of embodiments of display tile structure are given. For purposes of explanation, numerous specific details are set forth to provide a thorough understanding of the disclosure. Some of the drawings included in this disclosure show systems, devices or structures in schematic form or block diagram form, to better clarify the novel aspects of the disclosed concepts. In addition, in the interest of clarity, not all features of an actual implementation are described.

Exemplary, FIG. 6A shows a schematic diagram of a rectangular display tile in perspective view and FIG. 6B shows the same schematic diagram of a rectangular display tile in perspective view, only where surfaces are shown as transparent, for illustration only, showing component edges. In an embodiment, tile 600 resembles a thin box with an optical element mounted on top of it. The box dimensions are W mm wide, by H mm high, by D mm thick. W and H may be the same size (in which case, the display tile is square in shape), or of different size (in which case the display tile is rectangular in shape). Display tile dimensions W, H and D may vary between different embodiments. In an embodiment, display tiles W, H and D dimensions are such that it is convenient to hold them by one hand (for example, W, H may be between 50 mm and 300 mm and D may be between 5 mm and 50 mm). In another embodiment, W and H are less than 1000 mm and more than 10 mm in size. In another embodiment, W and H are less than 250 mm and more than 50 mm in size. In another embodiment, W and H are less than 200 mm and more than 75 mm in size, and D is less than 100 mm and more than 1 mm in size. In another embodiment, D is less than 50 mm and more than 5 mm in size. In another embodiment, D is less than 30 mm and more than 7.5 mm in size. In some embodiments, all display tiles in a single tile array have approximately the same dimensions (i.e. up to some variation may occur in manufacturing). In some embodiments, display tiles in a single tile array may have significantly different dimensions, as long as their dimensions and arrangement are such that they can connect to neighboring tiles—as a non-limiting example, some display tiles in a tile array may have W and H equal 100 mm and some display tiles in the same tile array may have W and H equal 200 mm.

In some embodiments, display tile 600 may include chassis 602. Tile 600 may include a display 610. Tile 600 may include connectors 604. Each connector 604 may include pins array 607. Tile 600 may include a printed circuit board (PCB) 620. In some embodiments, display tile 600 may also include permanent magnet 609, and/or cover glass 606, and/or optical element 603. In some embodiments, connectors 604 may include permanent magnets 605. In an embodiment, chassis 602 serves as the base component of display tile 600. Chassis 602 surrounds the display tile on all of its sides (e.g. its 4 sides) and/or on its bottom, houses electrical, optical and/or magnetic components, such as display 610 and PCB 620, and provides mechanical stability and support. In an embodiment, chassis 602 may also house permanent magnet 609. In an embodiment, holes on all sides of chassis 602 provide openings for connectors 604 (only some of them are seen from the angle of view in FIG. 6A, and for example four are visible in FIG. 6B). Connectors 604 allow for connecting adjacent display tiles in a tile array to each other, to transfer power, and/or data and/or control signals between neighboring tiles. In an embodiment, each connector of connectors 604 has two permanent magnets 605, each of which may be positioned so that a different magnetic pole is facing outwards of tile 600. In FIG. 6A, this is marked by letters N (indicating north magnetic pole of the magnet) and S (indicating south magnetic pole of the magnet), written next to permanent magnets 605. In an embodiment, the arrangement of all permanent magnets 605 in connectors 604 around the 4 sides of display tile 600 is such that it allows for connecting two adjacent tiles to each other on all sides of display tile 600, with magnets 605 applying magnetic forces to secure attachment. For example, such an arrangement may be as shown in FIG. 6B—a clockwise ordering of the magnetic orientation of permanent magnets in connectors on all 4 sides of tile 600 yields an interleaved arrangement, such as N S N S N S N S). In an embodiment, the shape of permanent magnets 605 may be different between magnets with north-pole facing outwards of a display tile and south-pole facing outwards of a display tile, to support solid attachment and good alignment between north-south matching magnets on matching connectors of display tiles that are attached one next to each other. For example, outward-facing north pole of permanent magnets 605 may have an extruding solid feature (e.g. a dome-shaped extrusion, a pyramid-shaped extrusion, a cylinder-shaped extrusion, etc.) out of its outward-facing face, and an outward-facing south pole of permanent magnets 605 may have an extruded cut with a matching shape (e.g. a dome-shaped extrusion cut, a pyramid-shaped extrusion cut, a cylinder-shaped extrusion cut, etc.).

In some embodiments, display tile 600 may include one or more speakers (not shown in FIG. 6A or FIG. 6B) that is capable of playing audio data. Audio data may be transferred to such a display tile in a similar way to passing image data intended to be displayed on it—as described in subsequent sections. Such speakers may be connected to PCB 620, and may be located beneath display 610 (or, in case display tile 600 has no display, beneath cover glass 606).

In an embodiment, each of connectors 604 also includes conductive pins array 607. When two display tiles 600 are placed one next to each other and are attached so that permanent magnets 605 on each display tile are well aligned and secured, matching conductive pins in conductive pins array 607 on each display tile touch each other and may transfer electrical power, data and/or control signals between neighboring tiles.

The shape, size and structure of connectors 604 may be different than illustrated in FIG. 6A and in FIG. 6B. For example, connectors 604 may be rectangular, square, or circular in shape, may be larger or smaller, conductive pins array 607 may have different number of pins and they may have different shapes and may be arranged differently, and magnets 605 may be different in shape, size and spatial arrangement in connectors 604.

In some embodiments, display tile 600 may include cover glass 606 that covers display 610 (herein the term “cover glass” may refer to any transparent or semitransparent cover part, which covers all or part of the front side of the respective tile; cover glass may be made of glass, or other materials, such as plastic, crystal, lead glass, sapphire etc.). Cover glass 606 may be mounted on top of the display and surrounding chassis 602, so that it covers display 610 entirely and also covers the edges of chassis 602 (so that it reaches up until the edge of display tile 600). In some embodiments, in case the display tile has no display, cover glass 606 may be mounted on top of PCB 620 or on top a surface replacing display 610. In an embodiment, display tile 600 may include cover glass 606 that covers display 610 but is surrounded by the edges of chassis 602 and does not cover them. In some embodiments, display tile 600 may include no cover glass 606.

In some embodiments, display tile 600 may include PCB 620. PCB 620 may include processing units, integrated circuits (ICs), communication and power buses, and other electrical components required to operate display tile 600 (for example, to receive and transfer power and information from/to neighboring display tiles, to process image information, to display image information, to drive display 610, to receive and send control signals, to process and transfer touch gestures etc.). In an embodiment, PCB 620 is connected to connectors 604. Then—a discussion about the PCB and its connection to connectors.

In some embodiments, display tile 600 may include display 610. Display 610 may be mounted on top of PCB 620 and connect to it via a flex cable (not seen). In an embodiment, driver IC (not seen) that drives the display is located on such flex cable. Preferably, in some embodiments, the shape of display 610 closely follows the outer shape of tile 600, with only thin (e.g. less than 1 mm or less than 0.5 mm or less than 10 mm) bezels surrounding the active pixel area of display 610. In some embodiments, such bezels may include non-active pixel area of display 610. In some embodiments, such bezels may also include the surrounding edges of chassis 602. In some embodiments, display 610 may be implemented according to various technologies such as LCD, LED, PMOLED, AMOLED, micro-LED, etc. In some embodiments, the pixel pitch of display 610 may be between 0.02 mm and 1 mm, preferably between 0.1 mm and 0.5 mm and more preferably between 0.2 mm and 0.4 mm. Such pixel pitch can support a viewing distance from several meters down to 60 cm, with the observer being largely unable (or, at least less able) to discern individual pixels. The total number of pixels included in display 610 depend on its physical size and the pixel pitch. For example, for a pixel pitch of 0.254 mm and a width and height of size of 101.6 mm, display 610 may include 400×400 pixels. As another example, for a pixel pitch of 0.15 mm, and a width of 120 mm and a height of 90 mm, display tile 610 may include 800×600 pixels.

In some embodiments, display 610 and/or cover glass 606 may be touch sensitive and have capability to sense touch gestures. For example, display 610 or cover glass 606 may be able to sense the position, intensity, and type of gesture of users touching the display tile (for example, by incorporating standard touch-panel technology into display 610 or cover glass 606). In some embodiments, touch-display is connected to PCB 620 via a flex cable (not seen). In an embodiment, a driver IC that drives the touch display is located on such flex cable (not seen).

Exemplary, FIG. 6C shows a schematic diagram of a rectangular display tile 600 of FIG. 6A, from its back side in perspective view. On its back side (facing the surface on which display tile 600 is mounted) chassis 602 includes extruded cut 608, shown as a hole in FIG. 6C, in which permanent magnet 609 located. Permanent magnet 609 may apply pulling forces on ferromagnetic layer 152, which hold display tile 600 in place on wall 150. In some embodiments, chassis 602 may have one or more such extruded cuts, and these cuts may be in different shapes and sizes. Each such cut may be filled with a permanent magnet (which, for example, may be glued to chassis 602) that fits the size and shape of such extruded cut.

In FIG. 6D and FIG. 6E, illustrative embodiments of connecting display tiles together, using connectors 654, 672 and 674, all similar to connectors 604, are given. In some embodiments, as shown in FIG. 6D, connector 670 may connect to display tile 660 and allow for connecting a display tile perpendicular to display tile 660. To achieve this, connector 670 may have two connectors, 672 and 674, that are located on perpendicular faces. Connector 670 may connect to two display tiles positions at a 90-degrees one relative to each other, thus enabling mounting a contiguous tile array over roughly perpendicular walls. In other embodiments, display tile 650 may have an extension 652 on its side, enabling display tiles to connect to it at 90-degrees angle. Exemplary, FIG. 6E shows tile array 680, including connected co-planar display tiles 682 and 684 (display tile 684 having an extension connector 685 on one of its sides—which may be an integral part of display tile 684, or an external connector) and a perpendicularly-connected display tile 686.

FIG. 6F shows a schematic diagram of a cross section of a rectangular display tile 600 of FIG. 6A in perspective view (cross section is obtained by cutting display tile 600 in the middle along a line perpendicular to its chassis 602). In this figure, an example for the arrangement of different components of display tile 600 is shown. As depicted in FIG. 6F, in some embodiments, display tile 600 may include optical element 603 that is mounted on top of cover glass 606 (or alternatively, if display tile 600 has no cover glass 606, optical element 603 is mounted on top of display 610 and/or edges 622 of chassis 602). Optical element 603 may modify the direction and/or intensity of light rays emitted from pixels in display 610 so that the image seen by observers looking at display tile 600 mitigates or completely masks the bezels that surround display 610 (due to non-active area in display 610 and/or edges 622 of chassis 602). In other words, the image seen by observers after emitted light from display 610 passes through optical element 603 is spread over the full size, or most of the size of display tile 600, and together with images displayed on neighboring display tiles (with similar such optical element 603), forms a large image that has no observable separating lines, or thinner observable separating lines between image parts originating from different display tiles, compared to a case where such no optical element 603 is included on display tiles.

Exemplary, FIG. 6G shows a schematic diagram of a cross section of a rectangular display tile 600 in side-view (cross section is obtained by cutting display tile 600 in the middle along a line perpendicular to its chassis 602). In this figure, a different example for the arrangement of different components of display tile 600 is shown, compared to FIG. 6F. In FIG. 6G, display 610 is mounted on top of PCB 620 and edges 622 of chassis 602, so that edges of chassis 602 do not surround the edges of display 610. Edges of chassis 602 on which display 610 is mounted may be thicker and wider compared to the case described in FIG. 6F, where edges 622 of chassis 602 surround display 610. The design shown in FIG. 6G may have the advantage of overall thinner bezels around the active area of display 610, compared to the design shown in FIG. 6F. Hence, optical element 613 in FIG. 6G may be similar or different than optical element 603 shown in FIG. 6F.

Exemplary, FIG. 6H shows a schematic diagram of a cross section of a rectangular display tile 600. In this figure, an example for the arrangement of components of display tile 600 is shown, that is similar to that shown in FIG. 6G. In the embodiment shown in FIG. 6H, no optical element is present on top of cover glass 606.

For the sake of simplicity, in FIG. 6A to FIG. 6H, optical element 603 is depicted as a single optical element. In some embodiments, optical element 603 may include several optical surfaces, some of which may be planar and some of which may be non-planar, with arbitrary shape. Optical element 603 may include layers, each made of a different optical material (such as, for example, different kind of glass, different kind of plastic, etc.).

In some embodiments, mounting optical element 603 or optical element 613 on top of cover glass 606 or on top of display 610, and also, mounting cover glass 606 on top of display 610 is achieved using optically clear adhesive (OCA) to bond the optical surfaces to each other, without hurting optical performance. In some embodiments, there may be an air gap between optical element 603 or optical element 613 may and at least part of cover glass 606 or display 610 (if cover glass 606 is not present), and optical element 603 or optical element 613 may be attached to cover glass 606 or to display 610 only at the borders.

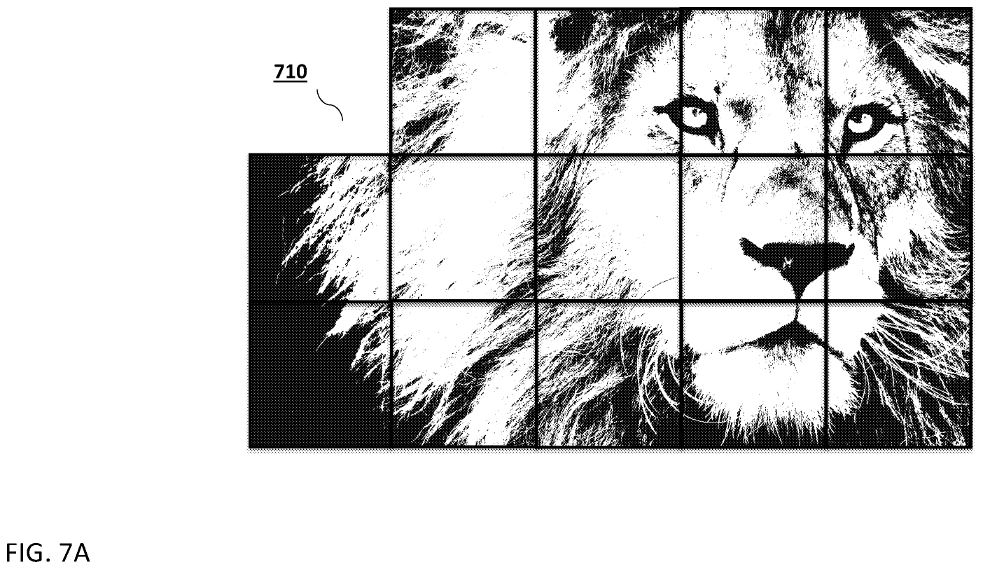

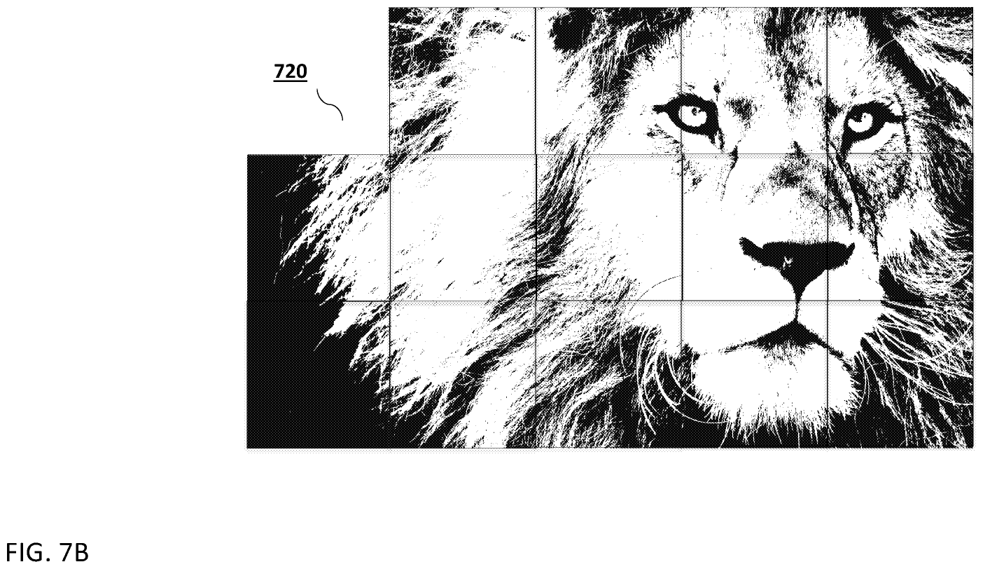

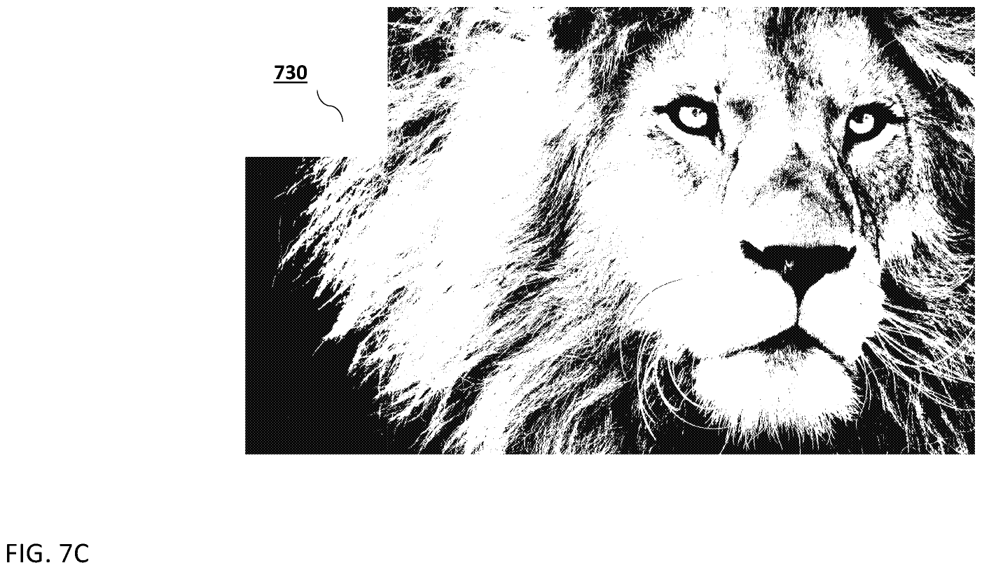

FIG. 7A, FIG. 7B and FIG. 7C illustrate the effect of including optical element 603 in display tiles forming a display tiles array. Referring to FIG. 7A, in some embodiments, display tiles forming tile array 710 do not include optical element 603. Exemplary, tile array 710 is configured to display an image of a lion. However, observers also see noticeable separating lines between display tiles, since no light is emitted from non-active area and from chassis edges around each display unit in display tiles forming tile array 710. Referring to FIG. 7B, in some embodiments, display tiles forming tile array 720 (similar to tile array 710) have an optical element (e.g. 603 or 613) over each of them, which may optically expand the displayed image in each tile, resulting in thinner observable separating lines between display tiles (for example, observable lines may be less than 75% the thickness of observable lines without an optical elements as mentioned above). Referring to FIG. 7C, in some embodiments, display tiles forming tile array 730 (similar to tile array 710) have optical element 603 or optical element 613 over each of them (which may be different than optical element 603 or optical element 613 included in display tiles forming tile array 720), which may optically expand the displayed image in each tile, thereby resulting in no observable separating lines between display tiles.

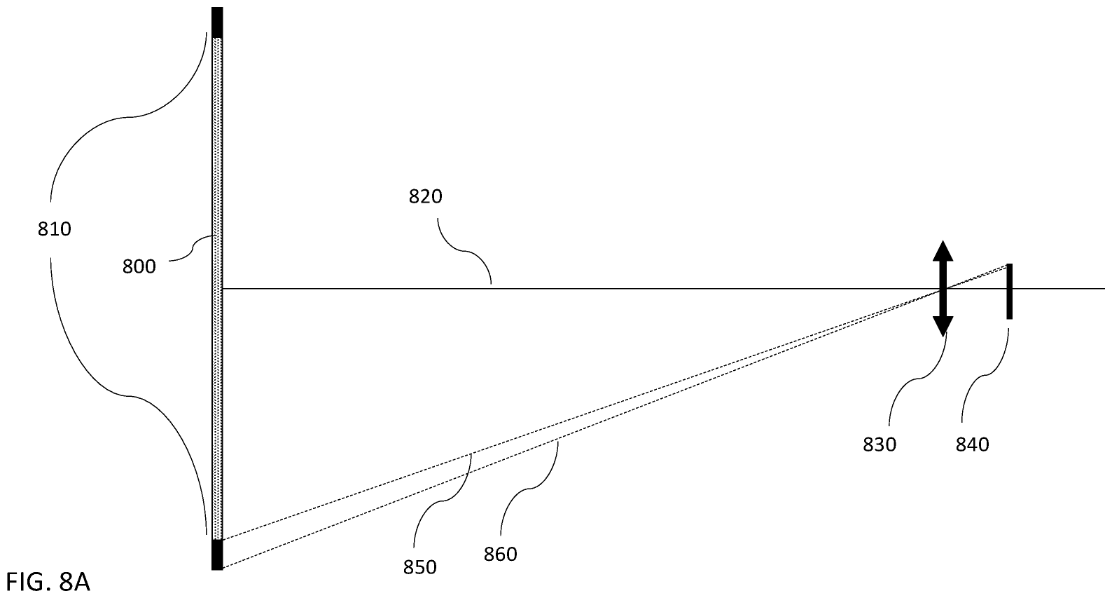

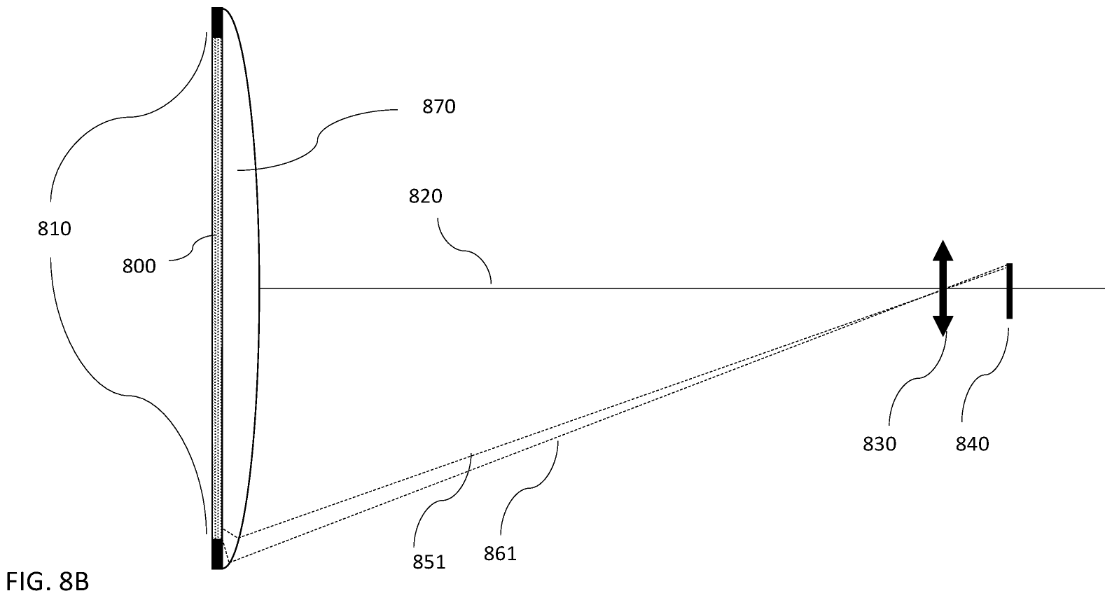

FIG. 8A and FIG. 8B show an illustration of the effect of placing said optical element on top of a display. In FIG. 8A, active area of display 800 is shown, with non-active display areas 810 that surround it (these are the bezels around the display active area 800). On optical axis 820, an observer, modeled as lens 830 and detector 840 is shown. Chief ray 860 reaches from the border of bottom non-active area 810 to the edge of detector 840. Chief ray 850 reaches from the bottom border of active area of display 800 slightly below the position of chief ray 860 on detector 840. The image formed on detector 840 therefore includes both display active area 800 and bezels 810 that surround it. In FIG. 8B, optical element 870 is added next to display active area 800 and non-active areas 810. Chief ray 861 originates from the border of display active area 800, is refracted by optical element 870 and reaches edge of detector 840. Chief ray 851 originates from near the border of display active area 800 (above origin of chief ray 861), is refracted by optical element 870 and reaches slightly below the position of chief ray 861 on detector 840. The image formed on detector 840 therefore does includes only an image of display active area 800, with no image of bezels 810 (or, in some embodiments, with an image of bezels 810 that appear thinner or equal compared to a case where optical element 870 is not present).

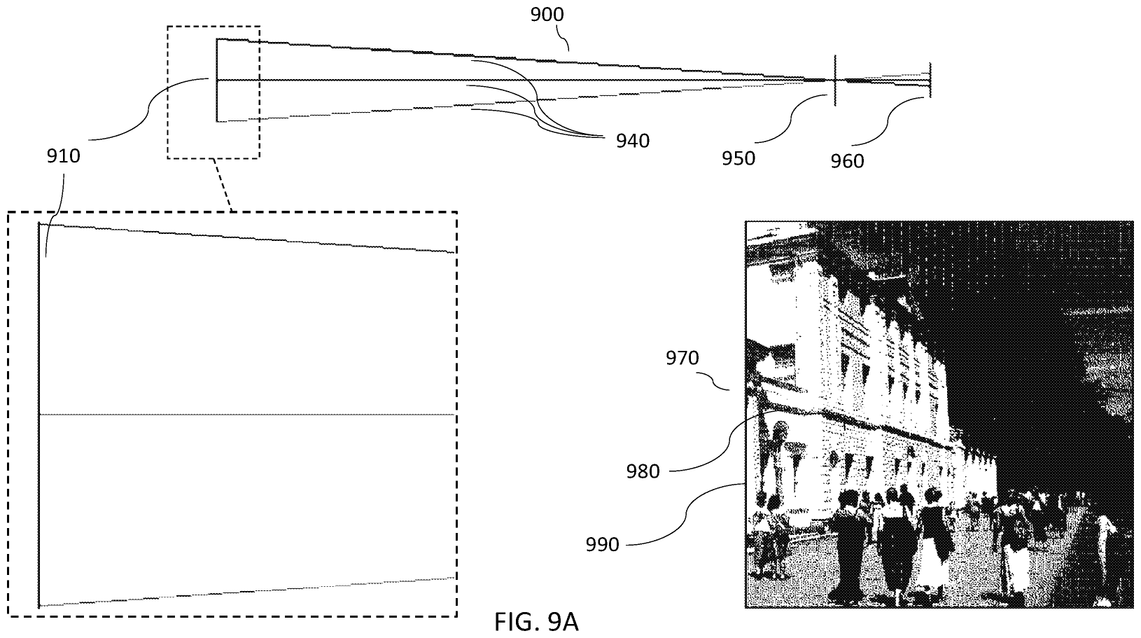

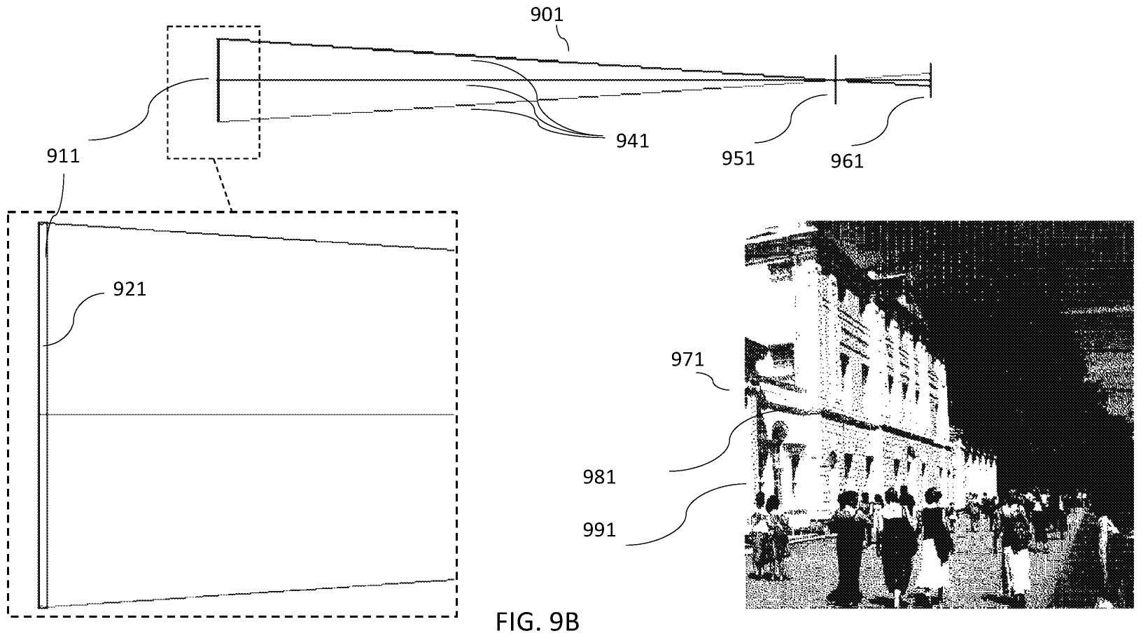

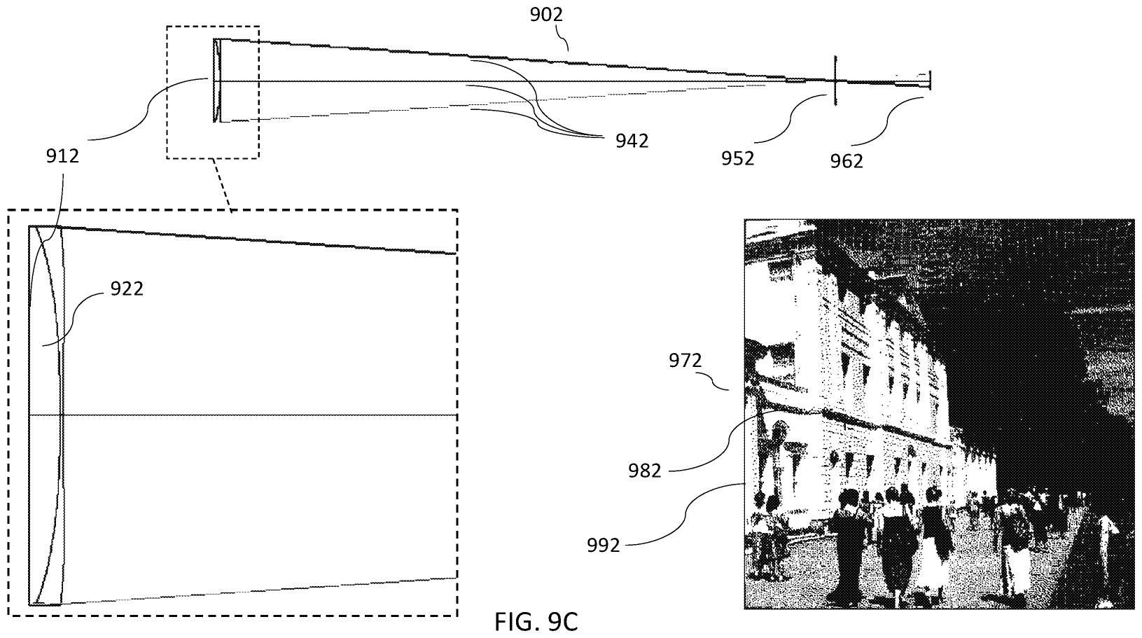

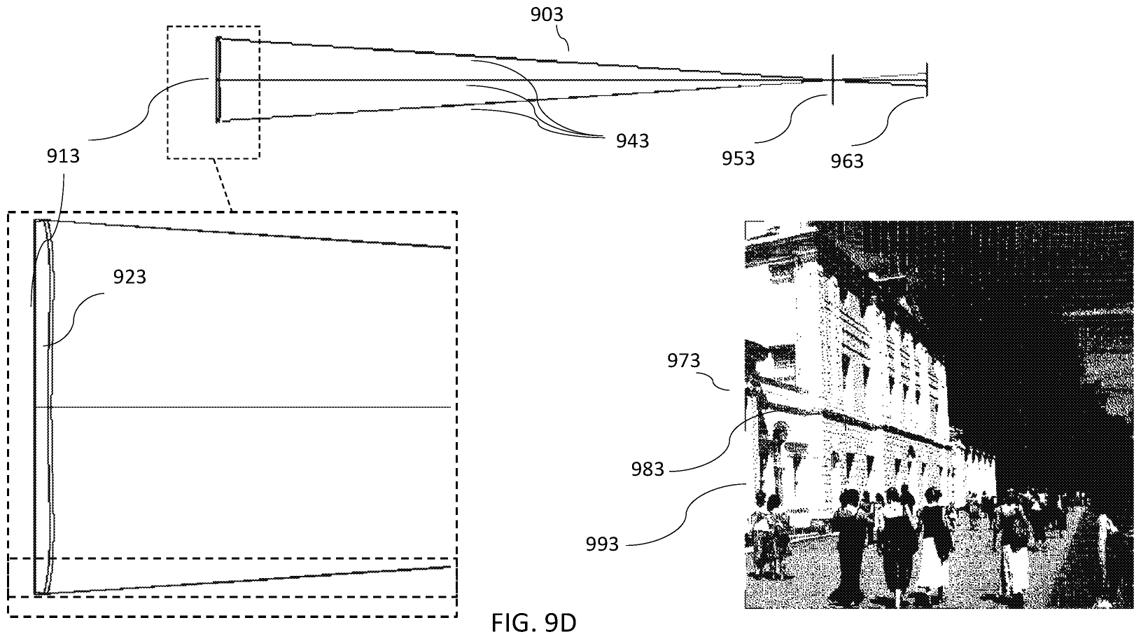

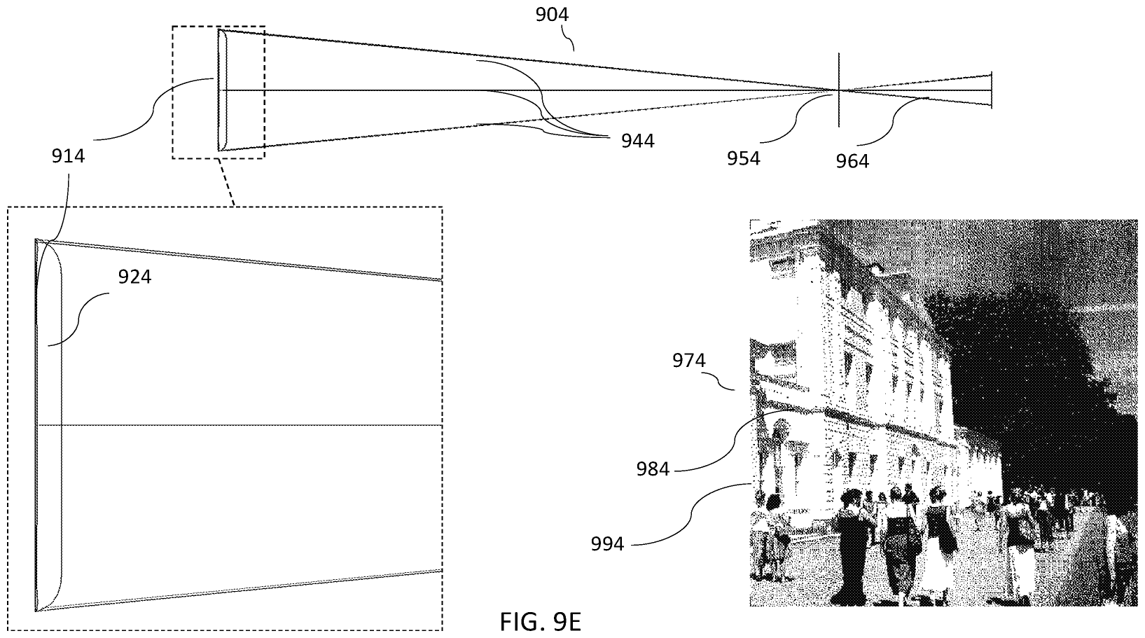

FIG. 9A, FIG. 9B, FIG. 9C and FIG. 9D show non-limiting illustrative embodiments of optical elements proposed herein. As non-limiting examples, in optical ray simulations depicted in these figures, the display tile active area of the display is taken to be a planar rectangular source with a rectangular aperture with half width and half height of 50.8 mm. A planar rectangular cover-glass with half-width and half-height of 51.3 mm and thickness of 0.25 mm, and with Refraction index (Nd)/Abbe number (Vd) of 1.46/67.8 is located right after the rectangular source. Observer is simulated as a paraxial lens with focal length of 100 mm and a detector positioned a certain distance (e.g. between 100 mm and 130 mm) from the paraxial lens, which corresponds to the focus point of the optical system. The paraxial lens is set to be at a distance of 75 cm from the cover glass (or from the optical element that covers it). This distance may be modified in simulation between 60 cm and infinity, to represent different observer distances. These values are given as an example only and are not material to the disclosure.

FIG. 9A shows optical ray simulation 900 of light rays, emitted from display tile 910 (also shown magnified in dashed frame), that includes no optical element. In optical ray simulation 900 of one embodiment, rays 940 are emitted from display tile 910, towards lens 950 and detector 960. Lens 950 and detector 960 together emulate an observer viewing display tile 910 from some distance. FIG. 9A also shows image simulation 970, that depicts how an image displayed on display tile 910 is imaged onto detector 960. Observed image shows valid image content 980, surrounded by black margins 990. Black margins 990 are the non-active bezels around the active display area of display tile 910, imaged through lens 950 onto detector 960.

Similarly, FIG. 9B shows optical ray simulation 901 of light rays, emitted from display tile 911 (also shown magnified in dashed frame), that includes optical element 921. In optical ray simulation 901 of one embodiment, rays 941 are emitted from display tile 911 towards lens 951 and detector 961 and are refracted by optical element 921. Optical element 921 may be a thin Fresnel lens, having a spherical profile or an aspheric profile, made of glass, plastic, polymer or other optical material or combination of optical materials. Table 1 shows an illustrative embodiment of optical element 921 with its optical properties. As known in the art, the surface sag is determined according to the following equation:

$$z = \frac{{cr}^{2}}{1 + \sqrt{1 - ( 1 + k ) {c}^{2} {r}^{2}}}$$

where r is the distance from (and perpendicular to) the optical axis, c=1/R, R is the radius of curvature, and k is the conic coefficient.

TABLE 1

| | | Radius of | | | Width × | |
|---|---|---|---|---|---|---|
| | | curvature | Thickness | | Height | Conic |
| # | Comment | [mm] | [mm] | Nd/Vd | [mm] | coefficient |
| 1 | Fresnel S1 | Infinite | 1.8 | 1.96/20.4 | 51.3 × 51.3 | |
| 2 | Fresnel S2 | −110 | 0 | — | 51.3 × 51.3 | −1 |

Optical element 921 is larger than the active area of display 911 and covers any bezels that may surround it. Rays focused by lens 951 form image 971 onto detector 961. Exemplary, as shown in image simulation 971, due to the refraction of light rays by optical element 921, imaged displayed image content 981 spans the entire support of image 971 and reaches up to borders 991 of image 971. In another embodiment, optical element 921 may reduce the width of black margins around imaged displayed image content 971, but not eliminate them completely.

Similarly, FIG. 9C shows optical ray simulation 902 of light rays, emitted from display tile 912 (also shown magnified in dashed frame), that includes optical element 922. In optical ray simulation 902 of one embodiment, rays 942 are emitted from display tile 912 towards lens 952 and detector 962 and are refracted by optical element 922. Optical element 922 may be a plano-convex lens, a bi-convex lens, or a positive meniscus lens, or other spherical or aspheric lens, or a cylindrical lens, or a toroidal lens, may be made of multiple surfaces, be made of glass, plastic, polymer or other optical material or combination of optical materials. As an example, Table 2 and Table 3 show an illustrative embodiment of optical element 922 with its optical properties. In this embodiment, optical element 922 is a lens with an aspheric surface. The equation for an even aspheric surface sag is well known in the art and can be expressed by:

$$z = \frac{c {r}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8}$$

with r is the distance from (and perpendicular to) the optical axis, c=1/R, R is the radius of curvature, k is the conic coefficient, and the alphas are polynomial coefficients. The parameters are as follows:

TABLE 2

| | | | | | | Conic |
|---|---|---|---|---|---|---|
| | | Radius of | | | Width × | coef- |
| | | curvature | Thickness | | Height | ficient |
| # | Comment | [mm] | [mm] | Nd/Vd | [mm] | k |
| 1 | S1 | Infinite | 9 | 1.96/20.4 | 51.3 × 51.3 | — |
| 2 | Even aspheric | −2000 | 0 | — | 51.3 × 51.3 | 0 |
| | S2 | | | | | |

TABLE 3

| # | α₁ | α₂ | α₃ | α₄ |
|---|---|---|---|---|
| 1 | — | — | — | |
| 2 | 1.1e−3 | −4.5e−7 | 2e−11 | −3e−15 |

Optical element 922 is larger than the active area of display 912 and covers any bezels that may surround it. Rays focused by lens 952 form image 972 onto detector 962. Exemplary, as shown in image simulation 972, due to the refraction of light rays by optical element 922, actual displayed image content 982 spans almost the entire support of image 972. Black margins 992 of image 972 are thinner in width compared to margins 990, when no optical element is included in display tile 910. In another embodiment, optical element 922 may refract light rays 942 such that black margins 992 are completely eliminated.

Similarly, FIG. 9D shows optical ray simulation 903 of light rays, emitted from display tile 913 (also shown magnified in dashed frame), that includes optical element 923. In optical ray simulation 903 of one embodiment, rays 943 are emitted from display tile 913 towards lens 953 and detector 963 and are refracted by optical element 923. Optical element 923 may have a surface sag with a smoothly varying shape. Its shape may have radial symmetry or X-Y symmetry. For example, such surface sag may be defined by polynomials in x and in y (and possibly combination thereof), by cubic splines, by a Bezier surface (defined by a set of control points in certain x and y coordinates), or by a list of surface sag values. As an example, Table 4 and Table 5 show an illustrative embodiment of optical element 923, with its optical properties. In this illustrative embodiment, optical element 923 sag is defined using polynomials in x and y:

z=α₁x²+α₂x⁴+α₃x⁶+α₄x⁸+α₅y²+α₆y⁴+α₇y⁶+α₈y⁸

where x and y are coordinates in a plane perpendicular to the optical axis, with the center (x=0, y=0) on the optical axis.

TABLE 4

| | | Radius of | | | Width × | Conic |
|---|---|---|---|---|---|---|
| | | curvature | Thickness | | Height | coefficient |
| # | Comment | [mm] | [mm] | Nd/Vd | [mm] | k |
| 1 | S1 | Infinite | 4.75 | 1.96/20.4 | 51.3 × 51.3 | — |
| 2 | Polynomial | — | 0 | — | 51.3 × 51.3 | — |
| | S2 | | | | | |

TABLE 5

| | | | Coeff on | Coeff on | Coeff on | Coeff on | Coeff on | Coeff on |
|---|---|---|---|---|---|---|---|---|
| # | Coeff on x\hat{ }2 | Coeff on x\hat{ }4 | x\hat{ }6 | x\hat{ }8 | y\hat{ }2 | y\hat{ }4 | y\hat{ }6 | y\hat{ }8 |
| 1 | — | — | — | — | — | — | — | — |
| 2 | 1.1e−3 | −4e−7 | 3.5e−11 | −3e−14 | 1.1e−3 | −4e−7 | 3.5e−11 | −3e−14 |

Preferably, optical element 923 sag changes smoothly across the area of display tile 913. Preferably, optical element 923 is a thin optical element (especially at its borders), with thickness up to 10 mm, more preferably with thickness up to 7 mm, and even more preferably with thickness up to 3 mm. Optical element 923 may be made of multiple surfaces, made of glass, plastic, polymer or other optical material or combination of optical materials. Optical element 923 is larger than the active area of display 913 and covers any bezels that may surround it. Rays focused by lens 953 form image 973 onto detector 963. Exemplary, as shown in image simulation 973, due to the refraction of light rays by optical element 923, actual displayed image content 983 spans the entire support of image 973 (perhaps with some residual black margins at the corners of image 973), reaching up to borders 993. In another embodiment, optical element 923 may refract light rays 943 such that black margins near borders 993 are decreased in width and not completely eliminated.

FIG. 9E further shows optical ray simulation 904 of light rays, emitted from display tile 914 (also shown magnified in dashed frame), that includes optical element 924. In optical ray simulation 904 of one embodiment, rays 944 are emitted from display tile 914 towards lens 954 and detector 964 and are refracted by optical element 924. The shape of optical element 924 may have a shape that may be defined to be largely flat over most of optical element 924 area and curving towards display 914, closer to its borders, and thus reaching minimal thickness at the borders—preferably, such thickness is below 2 mm, more preferably below 1 mm and even more preferably, below 0.5 mm. As an illustrative embodiment, the surface sag of optical element 924 may be defined as polynomials in x and y:

$$z = {\sum }_{i = 1}^{10} {\sum }_{j = 1}^{10} {{α}_{i j} ( \frac{x}{100} )}^{2 i} {( \frac{y}{100} )}^{2 j}$$

where x and y are coordinates in a plane perpendicular to the optical axis, with the center (x=0, y=0) on the optical axis, and the following list of coefficients:
α₁₀=α₀₁=−0.543
α₂₀=α₀₂=5.427; α₁₁=−8.329
α₃₀=α₀₃=23.897; α₂₁=α₁₂=38.668
α₄₀=α₀₄=−3.487; α₃₁=α₁₃=184.449; α₂₂=260.543
α₆₀=α₀₅=−5.801; α₄₁=α₁₄=−58.839; α₃₂=α₂₃=−526.031
α₆₀=α₀₆=−2907.641; α₅₁=α₁₅=−2412.175; α₄₂=α₂₄=−4680.8; α₃₃=−1.171E4
α₇₀=α₀₇=−1.944E4; α₆₁=α₁₆=−1.125E4; α₅₂=α₂₅=−1.821E4; α₄₃=α₃₄=−2.486E4
α₈₀=α₀₈=−9.4E4; α₇₁=α₁₇=−2.542E4; α₆₂=α₂₆=−3.142E4; α₅₃=α₃₅=−5.078E4; α₄₄=−1.161E5
α₉₀=α₀₉=3.941E5; α₈₁=α₁₈=5.257E4; α₇₂=α₂₇=1.564E5; α₆₃=α₃₆=1.585E5; α₅₄=α₄₅=1.601E5
α_{10,0}=α_{0,10}=−2.329E6; α₉₁=α₁₉=3.516E5; α₈₂=α₂₈=1.61E6; α₇₃=α₃₇=2.21E6; α₆₄=α₄₆=2.604E6; α₅₅=5.51E6
   In this illustrative embodiment, the border thickness of optical element 924 ranges between about 0.2 mm and about 0.5 mm.

Preferably, optical element 924 sag changes smoothly across the area of display tile 914. Preferably, optical element 924 is a thin optical element (especially at its borders), with thickness up to 10 mm, more preferably with thickness up to 7 mn. Optical element 924 may be made of multiple surfaces, made of glass, plastic, polymer or other optical material or combination of optical materials. Optical element 924 is larger than the active area of display 914 and covers any bezels that may surround it. Rays focused by lens 954 form image 974 onto detector 964. Exemplary, as shown in image simulation 974, due to the refraction of light rays by optical element 924, actual displayed image content 984 spans the entire support of image 974 (perhaps with some residual black margins at the corners of image 974), reaching up to borders 994. In another embodiment, optical element 924 may refract light rays 944 such that black margins near borders 994 are decreased in width and not completely eliminated.

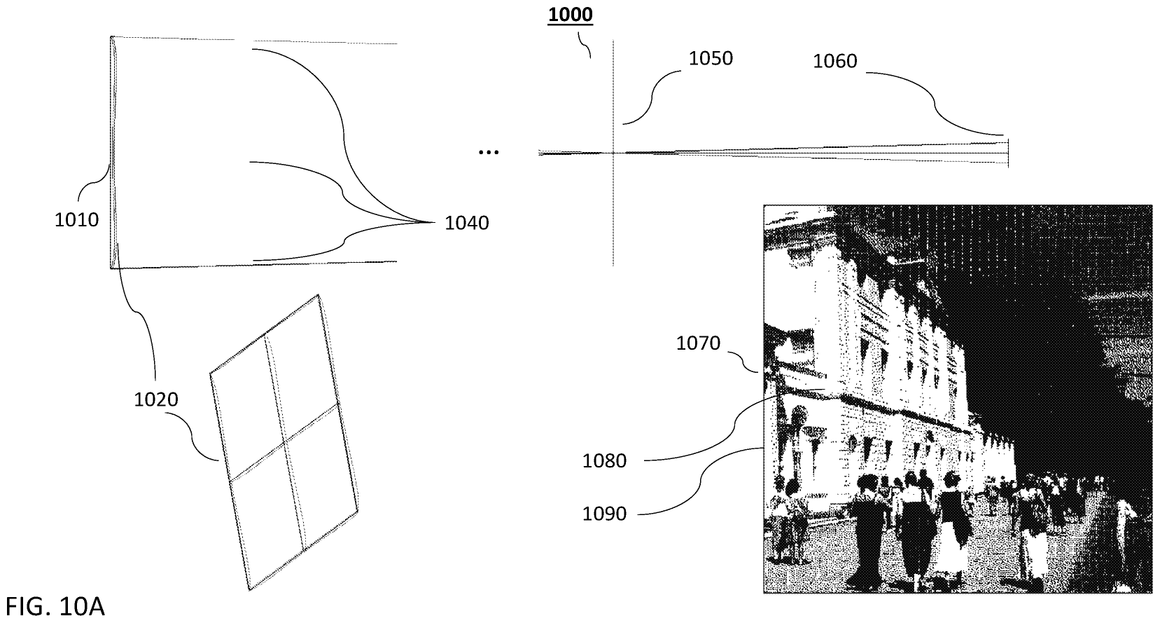

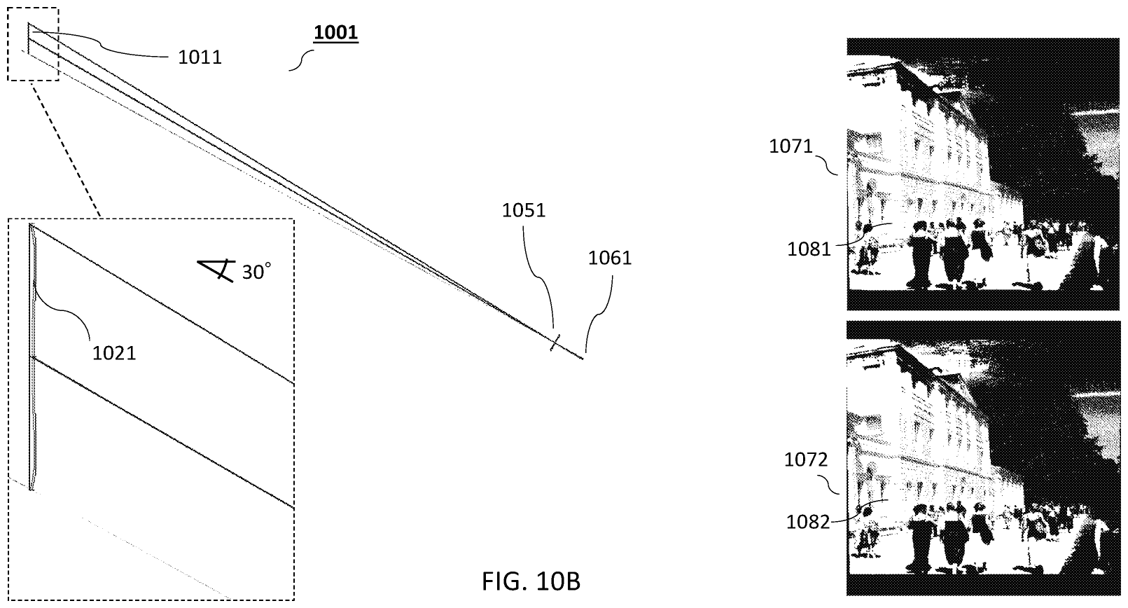

As can be appreciated from the illustrative embodiments given above, the operating principle of optical elements added to display tiles is to slightly expand the displayed image so that the bezels around the active area of the display will be mitigated or will not be seen at all by an observer looking at the display tile. An important aspect of optical element design is to keep the optical element as thin as possible, to avoid vignetting of the borders of the displayed image (due to rays hitting the edges of the optical element) when viewing the displayed image from a high angle of view (for example, 25-40 degrees). FIG. 10A and FIG. 10B show an illustrative embodiment of a display tile with a thin optical element at two observation angles—on-axis (viewing straight ahead, FIG. 10A) and at a 30 degrees angle (FIG. 10B). In FIG. 10A, optical ray simulation 1000 is shown, with display 1010, lens 1050 and detector 1060 located 2 m away, modeling an observer viewing display 1010 heads-on (lens 1050 and detector 1060 are shown separately from display 1010, to better show detail of each component of the system). Light rays 1040 originating from display tile 1010 are refracted by thin optical element 1020 (also shown enlarged) and are viewed by lens 1050 and detector 1060. Image simulation 1070 shows active displayed image 1080 (as imaged by lens 1050 onto detector 1060), with narrower black margins 1090 compared to the case where no optical element is used (as can be seen in FIG. 9A). In this illustrative embodiment, optical element 1020 is a defined as a polynomial surface, with optical parameters shown in Table 6 and Table 7.

TABLE 6

| | | Radius of | | | Width × | Conic |
|---|---|---|---|---|---|---|
| | | curvature | Thickness | | Height | coefficient |
| # | Comment | [mm] | [mm] | Nd/Vd | [mm] | k |
| 1 | S1 | Infinite | 1.5 | 1.96/20.4 | 51.3 × 51.3 | — |
| 2 | Polynomial | — | 0 | — | 51.3 × 51.3 | — |
| | S2 | | | | | |

TABLE 7

| | | Coeff on | Coeff on | Coeff on | Coeff on | Coeff on | Coeff on | Coeff on |
|---|---|---|---|---|---|---|---|---|
| # | Coeff on x\hat{ }2 | x\hat{ }4 | x\hat{ }6 | x\hat{ }8 | y\hat{ }2 | y\hat{ }4 | y\hat{ }6 | y\hat{ }8 |
| 1 | — | — | — | — | — | — | — | — |
| 2 | 1.2e−3 | −4.2e−7 | 1.1e−10 | −6.25e−14 | 1.2e−3 | −4.2e−7 | 1.1e−10 | −6.25e−14 |

FIG. 10B shows optical ray simulation 1001 the same display tile 1011 (the same as display tile 1010) with optical element 1021 (the same as optical element 1020) mounted on it, but in this case the observer (modeled as lens 1051 and detector 1061, both are the same as lens 1050 and detector 1060) is viewing display tile 1011 at an angle of 30 degrees. Display tile 1011 with optical element 1021 are also shown magnified with light rays originating from it at a 30 degrees angle. Image simulation 1071 of observed image 1081 is shown for this case, and image simulation 1072 is shown for the case of 30 degrees tilted viewing, but with no optical element is included in tile 1011. It can also be appreciated that the imaged active display image (or observed image) 1081 is expanded compared to imaged active display image 1082 and that no vignetting occurs in the borders of the observed image in the case where optical element 1021 is used. It is noted that the observed images (with or without optical element 1021) undergo perspective distortion due to the tilted viewing angle.

For the sake of conciseness, the non-limiting examples given in section titled “Display tiles structure” for display tiles structure refer to rectangular display tiles. However, in some embodiments, display tiles may not necessarily be rectangular in shape—for example, display tiles that are triangular in shape (for example, equilateral triangles) with 3 edges, or display tiles that are hexagonal in shape (for example, regular hexagons) may also be considered, with the modifications resulting from the different number of edges, and consequently, the different number of potential neighboring tiles each display tile has (among these modifications, for example, are the number of connectors, the number of receivers and transmitter components inside the tile, the number of conductive pins, the shape of the optical element, the mode of operation and control of each tile, etc.). FIG. 11 illustrates embodiments of such tiles—tiles array 1100 shows an array made of equilateral triangular tiles and tiles array 1110 shows an array made of hexagonal tiles. In some embodiments, for both triangular and hexagonal tiles, the separating black lines between the tiles represent the bezels between tiles and may be mitigated or eliminated using optical elements as described herein.

### Display Tiles Architecture and Functionality

In some embodiments, information may be stored in NVM unit 1212 during production of display tile 1200, read from NVM unit 1212 by processing unit 1210 and used by it during display tile 1200 operation. For example, such information may include information collected during measurements performed on display tile 1200 during its production (for example, in a calibration and measurement station in the production line), such as color calibration information of displayed image (e.g. measured responses of different colors emitted by different regions of display tile 1200), intensity information of displayed image (e.g. measured responses of light intensity emitted by different regions of display tile 1200), geometric information of displayed image (e.g. geometric distortion, scale in x and y, shifts in x and y, and/or rotations of the image displayed from display tile 1200, especially when display tile 1200 includes an optical element, such as described in section “Display tiles structure”). In some embodiments, other information may be stored in NVM unit 1212 and used by tile processing unit 1210 during operation. Such information may include a set of instructions (such as binary code) for running on a processor for operating tile 1200, configuration parameters (e.g. display tile resolution, pixel pitch, optical element properties, if such exists, etc.), an identifying number, a version number, pseudo-random seed numbers that may be used during communication between display tiles, etc. In some embodiments, collecting and storing such information during production is done per manufactured tile. Such data is read and used during different stages of tile operation, for example, during initialization, during communication with neighboring tiles. Calibration data in particular may be used when image data intended to be displayed on the tile is processed by tile processing unit 1210, to increase uniformity and mitigate (or eliminate) differences in color, intensity or any geometric inconsistency between tiles that are connected together as part of a display tile array.

In some embodiments, tile processing unit 1210 may be connected to driver IC unit 1220 that is responsible to driver the display pixels of display 1221 in tile display unit 1200. In some embodiments, display 1221 may also include touch capabilities and driver IC unit 1220 may include a touch driver IC. Display driver IC and touch driver IC may be separate ICs, or one combined IC, may be located on the same PCB 620 over which tile processing unit 1210 is located, or located on a separate substrate, or located on the flex cable connecting to display 1221. In some embodiments, tile processing unit 1210 may send information to driver IC unit 1220 that may include pixel data, intended to be displayed by display 1221. Such information may be sent several times per second, according to a predefined refresh rate for display tile 1200 (such refresh rate may be determined by an MPU 400 (that may configure the operation of display tile 1200), according to, for example, application considerations, bandwidth limitation, user input, etc. In some embodiments, driver IC unit 1220 is also configured to receive touch coordinates and/or gestures (such as tap, double-tap, swipes, pinch, etc.) from a touch layer or component that may be part of display 1221, and to relay them to tile processing unit 1210.

In some embodiments, tile processing unit 1210 may be connected to speaker driver IC 1216, that is responsible to drive speaker 1217, to produce sound. Audio information may be sent to display tile 1200 from MPU 400.

In some embodiments, display tile 1200 may include power control and power circuitry unit (power unit) 1230, that connects to power interfaces 1231, that are located at least one on each side of tile 1200 that may connect to another display tile, and include some of the pins in pins array 607 in connectors 604 (referred to in FIG. 6A and in section “Display tiles structure” above). Power unit 1230 controls and manages power (i.e. current, voltage) received in display tile 1200 through one or more power interfaces 1231 from neighboring display tiles or directly from an MPU (via a connecting cable). Power unit 1230 may provide voltages and/or currents for all units of display tile 1200, such as processing unit 1210, NVM unit 1212, driver IC unit 1220, speaker driver IC 1216 and speaker 1217. Power unit 1230 may determine whether display tiles are connected to display tile 1200 and on which sides (for example, by sensing resistance and/or voltage and/or current in one or more pins in pins array 607 on all sides of display tile 1200, or on power buses or lines in PCB 620 of display tile 1200 that may be connected to such pins).

In some embodiments, display tile 1200 may further include data and control interfaces 1215, at least one on each side of display tile 1200 that may connect to another display tile. Data and control interfaces 1215 allow transferring data and control signals between neighboring display tiles or between display tile and an MPU 400. Data and control interfaces 1215 connect to tile processing unit 1210, that is in charge on receiving, processing and sending control signals and/or messages, and on receiving, processing and sending data between neighboring display tiles through data and control interfaces 1215. Data and control interfaces 1215 may use electrical connectors, such as pins in pins array 607 in connectors 604 (referred to in FIG. 6A and in section “Display tiles structure” above) to transfer control signals and data. In some embodiments, data and control interfaces 1215 include a high-bandwidth data bus and I/F and a separate control bus and I/F, both of which are capable of transferring data and control signals in two directions—inwards, from neighboring tiles into tile 1200, and outwards, from tile 1200 to neighboring tiles. As an example, such interfaces may include one or more HDMI, DVI, DisplayPort, MIPI DSI, USB, USB-C hardware and interface hardware. In some embodiments, tile processing unit 1210 determines which interface of the data and control interfaces 1215 of display tile 1200 should receive data from a neighboring tile and which interface should transmit data to neighboring tiles. Tile processing unit 1210 may determine the inwards/outwards orientation of each data and control interface during operation, based, among on other factors, on information received from an MPU 400. In some embodiments, transferring control signals over data and control interfaces 1215 may be done in both inwards and outwards directions on each of the interfaces, during operation. In some embodiments, display tile 1200 may have a single data and control interface 1218 that may include wireless hardware and interfaces (for example, WiFi, 3G, 4G, 5G, Bluetooth devices, etc.). This data and control interface may support transfer of frame data information from an MPU to display tile 1200, control signals between an MPU and display tile 1200 and vice versa, and/or transfer of frame data information and/or control signals between display tile 1200 and other display tiles. In some embodiments, display tile 1200 may have a combination of a single data and control interface 1218 that includes hardware and interfaces for wireless communication and data transfer (including frame data transfer and control signals), and multiple wired hardware interfaces 1215 on each of its sides to enable connection to neighboring display tiles, that support transfer of frame data and/or control signals.

In some embodiments, tile processing unit 1210 may apply common image processing transformations on image data that it receives periodically and is intended to be displayed. Such transformations may include, for example, cropping the image to a certain size (e.g. eliminating borders or keeping only a part of the image data), scaling the image (e.g. upscaling a low-resolution image to a higher resolution image, or downscaling from a high resolution image to a lower resolution image), binning the image, subsampling the image, applying geometric transformations such as rotations, translations, skew, projections, distortion, frame color transformations (for example, modifying hue, intensity and color saturation), format transformations (for example, converting from YUV420 to RGB values), etc. Rate transformations (e.g. reducing or increasing the rate of displayed image data compared to received image data) may also be applied on an incoming stream of frames.

In case display tile 1200 includes an optical element, for example, the illustrative embodiments discussed in section “Display tiles structure”, such optical element may possibly expand the displayed image in a non-uniform manner—for example, parts of the displayed image may expand more than other parts (in particular, the borders of the displayed image may expand more than its center, and corners may expand more or less than the center of an edge). This may introduce distortion to the displayed image. In some embodiments, the image displayed on the display tile may be pre-distorted or pre-warped digitally by tile processing unit 1210 (for example, by applying signal processing operations, as discussed in the previous paragraph, on the digital image before it is displayed) according to a distortion profile that corresponds to the distortion applied by the optical element. In this case, calibration information regarding the optical element distortion profile, stored in NVM unit 1212 may be read and used by tile processing unit 1210 to mitigate or eliminate observed distortion.

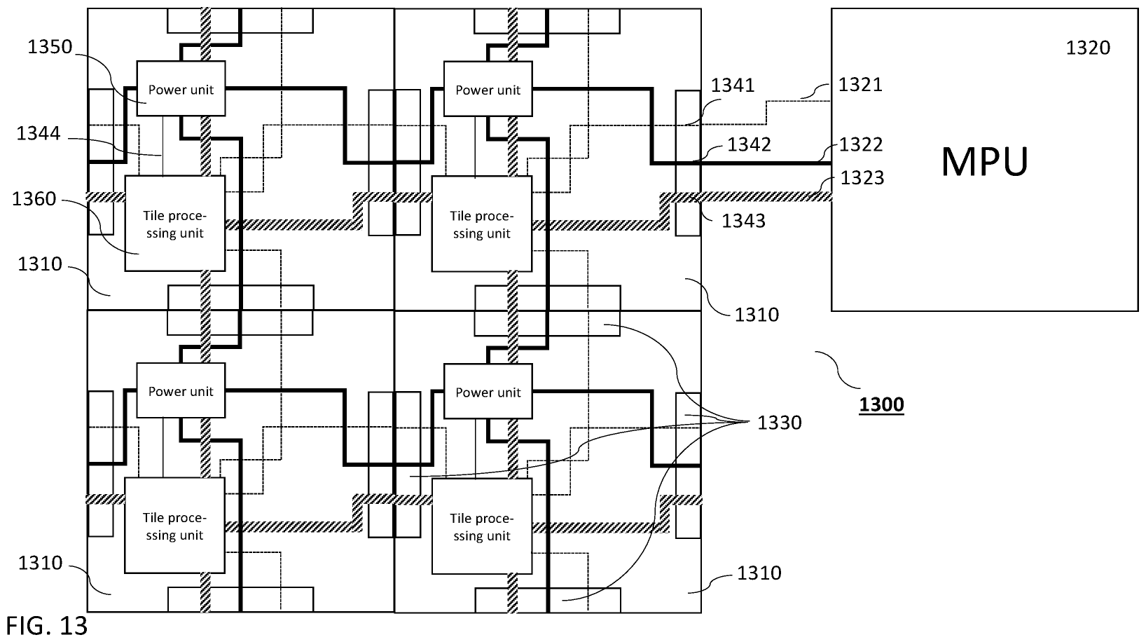

FIG. 13 shows a schematic diagram of MDS 1300, comprising MPU 1320 and four display tiles 1310. In this example, MPU 1320 is connected to the top-right display tile of the four display tiles 1310, that together form a display tiles array. In some embodiments, three connections may connect MPU 1320 and the display tile—first, MPU connection 1321 is a bidirectional communication channel that is used to transfer control signals and control messages between MPU 1320 and display tiles 1310, in both directions. It may include one to several wires (or pins among pins array 607 in connectors 604, referred to in FIG. 6A and in section “Display tiles structure” above), or may be implemented via a wireless communication channel. It connects to control bus 1341 on the display tile side; Second, MPU connection 1322 (which connects to bus 1342 on the display tile side) is a power connector that relays power from MPU 1320 to display tiles array; Third, high speed data channel 1323 transfers image data from MPU 1320 to display tiles 1310. High speed data channel 1323 connects to data bus 1343 on the display tile side. It may include one to several wires or may be implemented via a wireless communication channel. Each of display tiles 1310 has interfaces 1330, one on each side, that connect display tiles 1310 to each other and to MPU 1320. Interfaces 1330 may include electrical connections, circuitry, electronic components and/or logic to connect to pins array 607 in connectors 604 (referred to in FIG. 6A and in section “Display tiles structure” above), transfer electrical signals over pins in pins array 607 and/or sense electrical signals over them. In some embodiments, display tiles 1310 may have wireless communication interfaces (not shown) to send and receive electrical signals (including frame data and control signals) to/from MPU 1320, either in addition to interfaces 1330, or instead of part of interfaces 1330 (for example, part of interfaces 1330 may not be required).

In some embodiments, inside each of display tiles 1310, power bus 1342 is connected to a power unit 1350 and provides electrical power required to operate the electronic circuits and display in display tile 1310. Power bus 1342 is connected between power unit 1350 and each of interfaces 1330 (one may exist on each side of each display tile of display tiles 1310). In some embodiments, each of power buses 1342 in one tile connects to power bus 1342 in neighboring tile (and all internal power buses in a tile are connected together, perhaps with some support circuitry between connections), thereby creating a power grid over which the supply voltage is the same as supplied by MPU 1320 (with each connected tile drawing as much current it requires to operate).

In some embodiments, inside each of display tiles 1310, control bus 1341 is connected to tile processing unit 1360, where signals and/or messages may be received, parsed and sent to neighboring display tiles (through connections 1341) or to MPU 1320 (through connection 1321). In some embodiments, one control bus 1341 exists between tile processing unit 1360 and each of display tile interfaces 1330, and tile processing unit 1360 may send and receive messages and/or control signals from each of control buses 1341, parse them and act upon them as defined in tile processing unit 1360 instructions, and/or relay such signals and/or messages to neighboring display tiles or to MPU 1320 (through control buses 1341).

In some embodiments, display tiles may be able to detect whether other display tiles are connected to them, or disconnected from them, and on which side they may be connected-to or disconnected-from. Detection of connected or disconnected display tiles may be done through detecting current flows in electrical connections. For example, in one display tile, power unit 1350 may be connected to tile processing unit 1360 through bus 1344 and provide information about which other display tiles are connected-to or disconnected-from a display tile, for example, by detecting whether current flows in the relevant power bus of power buses 1342. Another example for detecting connected or disconnected display tiles may be via impedance measurement—in FIG. 13, interfaces 1330 in a display tile may each include a 2 T/4 T sensing circuit (or a similar circuit for measuring impedance) to measure impedance over one or more pins in pins array 607 in connectors 604 (referred to in FIG. 6A and in section “Display tiles structure” above). Another example for detecting connected or disconnected display tiles may be via voltage measurement on at least one of the pins in pins array 607 in connectors 604 (referred to in FIG. 6A and in section “Display tiles structure” above). In another illustrative embodiment, a mechanism in a display tile for detecting connected or disconnected display tiles may include sensing changes in magnetic field that may happen when fixed magnets 605 (that are part of connectors 604, as shown in FIG. 6A and explained in section “Display tiles structure”) in a connected tile apply magnetic forces on fixed magnets 605 in said display tile (e.g. due to physical proximity of the former to the latter). Such sensing may be carried out using standard Hall effect sensors. A combination of methods mentioned above may also be used in some embodiments.

Interfaces 1330 may be connected to tile processing unit 1360 (connections not shown in FIG. 13) and may send information about measured impedance, current, voltage or changed magnetic field to it, during display tile operation. Display tiles may inform MPU 1320 of a change in neighboring connected display tiles (for example, an addition of a new connected display tile or a removal of a connected display tile). This may be done, for example, by tile processing unit 1360, that may send messages or signals to MPU 1320 over control buses 1341, through connection 1321.

In some embodiments, connection 1321 and control buses 1341 may transfer a synchronization signal, that may originate at MPU 1320 and may be used to synchronize the time when the displayed image is refreshed on some or all display tiles' displays—so that part of or the entire tile array refreshes the displayed image at about same time (or, at least with a time difference between different display tiles that seems negligible to users observing the tile array). In some embodiments, a dedicated pin in pins array 607 in connectors 604 (referred to in FIG. 6A and in section “Display tiles structure” above) may be used to transfer this synchronization signal. In some embodiments, connection 1321 and control buses 1341 may transfer a parameters-update signal, that may originate at MPU 1320 and may be used to synchronize the time of updating parameters (for example, routing tables, color gains, etc.) over some or all display tiles.

In some embodiments, in each of display tiles 1310, data bus 1343 is connected to tile processing unit 1360, where frame data may be received, possibly processed, and sent to be displayed on the tile's display, or may be routed to another neighboring tile (or discarded). In some embodiments, each of display tiles 1310 has a high-speed data bus 1343 connected to each of its interfaces 1330 (i.e. 4 such buses in the example shown in FIG. 13), and through these interfaces, connecting to high-speed data buses 1343 of neighboring display tiles and thereby enabling transfer of frame data, messages and/or signals from one tile to neighboring tiles. This enables routing of frame data, messages and/or signals from one display tile to a neighboring display tile, propagating data between different display tiles in the display tiles array. As an example, MPU 1320 may send image data over data connection 1323 that is intended to be displayed on the bottom-right display tile in the display tiles array, which is not directly connected to MPU 1320. A display tile connected to MPU 1320 (the top right display tile in FIG. 13) may receive this data through one of its interfaces 1330, and route it to a different interface of interfaces 1330 that is connected to the bottom-right display tile. Routing may be determined in tile processing unit 1360 and the data may be transferred through data buses 1343 to its destination display tile, where it may be displayed. In some embodiments, data connection 1323 between MPU 1320 and display tiles 1310 is implemented over wireless communication, and frame data may be transferred directly from MPU 1320 to each of display tiles 1310 via a direct channel, without the need to route messages and/or signals from one tile to another until reaching a destination.

### Modes of Operation and Communication Between MPU and Display Tiles Array

As explained in the previous sections, an MPU and a display tiles array, which together compose the main two parts of an MDS, need to transfer data and control signals between them efficiently, for adequate operation of the system. This section discusses details about communication between an MPU and display tiles in a display tiles array, during different modes of operation of the system.

As shown in FIG. 13, in some embodiments, several communication channels between MPU 1320 and display tiles 1310 exist, for transferring image data messages and control messages and signals between them. In some embodiments, at least part of the communication is packet-based, with each packet containing information (e.g. frame data to be displayed, or control message), with an origin and a destination. Packets may originate in the MPU with its destination being one of the display tiles (for example, it may include frame data that the display tile should display in the next frame), and it may be routed to its destination display tile through the array of display tiles, by means of routing tables, present at each display tile. In some embodiments, at least part of the communication may be based on signals, broadcasted to the entire array of display tiles. In such a case, display tiles may all be connected to an MPU (for example, using several pins in their side-connectors, forming together a connected grid), and a signal originated from an MPU may be received by such display tiles at approximately the same time, causing some synchronized action to be performed across all display tiles. For example, such signals may be used to indicate refreshing of the displayed data, updating routing tables, etc.

In some embodiments, communication between an MPU and a tile array may include transferring frame data from an MPU to display tiles, which is done over a high-speed high-bandwidth communication channel (“data channel”), and also transferring control messages from MPU to display tiles and from display tiles to an MPU, which may be done over a separate bidirectional communication channel (“control channel”), which can operate at a lower rate than that of the data channel. In some embodiments, the communication protocol over the control channel may include sending acknowledgement messages from a display tile to an MPU, after receiving a message intended for it.

Following is a description of the operation of an MPU and tile array during system initialization phase, and during standard operation (i.e. frame streaming):

### Initialization

In some embodiments, initialization phase may take place when an MDS transitions from shut-down or standby phase (during which it may not be fully operational) to a fully operational phase (during which it may receive incoming streams and stream frames to its display tiles array). In some embodiments, during initialization phase, an MPU may perform initialization tasks such as, for example, allocate resources needed for operation (e.g. memory, data structures), load configuration parameters (and also user configuration parameters), activate hardware, initialize registers and variables with values, prepare to start processing jobs, scan incoming input streams from external devices, and other similar tasks. In addition, initialization tasks (resource allocation, loading configuration, activating hardware, initializing registers, detect neighbors, etc.) may also occur in each display tile during initialization. Importantly, to function correctly, an MPU has to be aware of the tile array size, structure, the orientation between display tiles and the connections between them. For example, this information is necessary to determine the assignment of input streams to areas onto a display tiles array, to route image data intended to be displayed correctly to different display tiles, to determine the refresh rate (i.e. frame rate) of the display tiles array, etc. In some embodiments, an MPU may produce a representation (such as a map, graph, etc.) of display tiles' type, arrangement and connections for the entire tile array connected to it.

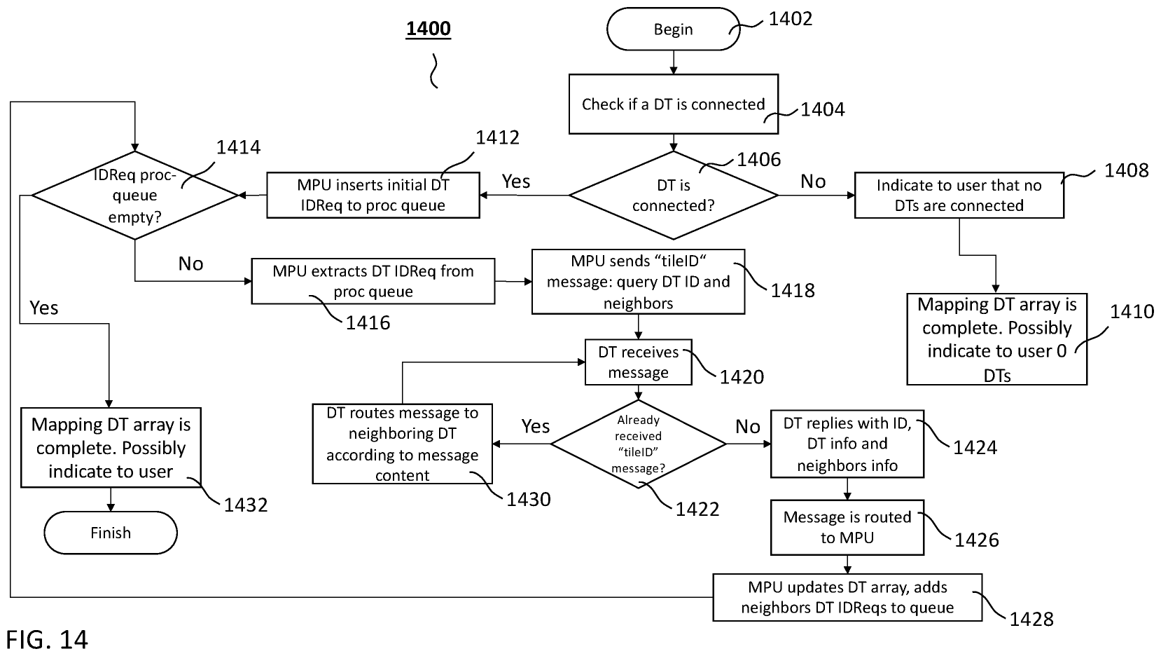

Exemplary, FIG. 14 illustrates process 1400 of mapping tile array connected to an MPU, through a sequential exchange of messages between an MPU and display tiles. Step 1402 marks the beginning of the process. In step 1404, an MPU may check whether a display tile (referred-to as DT in FIG. 14 and henceforth) is connected to it through a connection cable (e.g. such as cable 104 and connector 106, shown in FIG. 1A), for example through a sensing mechanism as described in section “Display tiles architecture and functionality”. Condition 1406 checks the status—in some embodiments, if no display tiles are connected, MPU may indicate to the user that no display tiles are connected (step 1408), for example, using its light indicator, or showing a message on a user's mobile device or remote control. In this case, the mapping of the tile array is complete, with no display tiles detected (step 1410). In some embodiments, if display tiles are indeed connected, MPU may prepare a processing queue and add to it an initial display tile ID request (denoted “DT IDReq” hereafter) (step 1412). A DT IDReq in the processing queue is a token indicating that there exists a specific display tile that is yet to be mapped and needs to be identified. In some embodiments, each DT IDReq may hold the sequence of routing steps describing how to reach the corresponding display tile from the MPU. For example, for square display tiles with 4 connectors (one on each display tile's edge) marked N, S, E, or W (stands for north, south, east and west, respectively, although there is no relation to geographic directions), the sequence of routing steps may include the choice of connector at each of the display tiles along the route—from the MPU, through the first display tile connected to the MPU, and followed by a neighboring display tile, etc., until the destination display tile is reached. An example for such a routing sequence may be: N-E-E-N-N-E (meaning, reach first display tile connected to the MPU, route through its N connector, then in the next display tile route through its E connector, then again E, N, N, and finally E again). In some embodiments, when an initial DT IDReq is inserted to the processing queue, the routing sequence included in it is empty, corresponding to the first display tile connected to the MPU (since there is a need to map this display tile first, before any other). In some embodiments, following the generation of a processing queue, an iterative process begins, in which the queue is checked for members (condition 1414), and if it's not empty, the first DT IDReq is extracted from it (step 1416). In some embodiments, in the next step 1418, the MPU then may construct a special message, denoted herein “tileID message”, requesting from the destination display tile to send back its ID, whether a neighboring display tile is connected to each one of its connectors (perhaps, apart from the one through which the message comes), and tile-specific-information about itself (for example, its type, whether it has display capability, touch capability, its resolution, firmware/software version, wireless capability, wireless connection information required to establish wireless link with the display tile—e.g. address, channel, frequency, communication protocol, encryption information, etc., and other data that may be important for the correct operation of a display tiles array). In some embodiments, the tileID message may include also the routing sequence from the corresponding IDReq message. In some embodiments, the MPU may send the message to the tile array over the control channel, and it is received by a display tile (step 1420), where a check is performed (condition 1422) whether a tileID labeled message already received in said display tile or not, during its current operation period (for example, since it was last turned on). In some embodiments, if the receiving display tile haven't received such a message yet, then it is the designated display tile and the message is intended to reach it. First, the display tile processing unit may mark the connector through which the tileID message arrived as the direction of the MPU (to route messages back to the MPU correctly). Then, the display tile may reply with a message to the MPU containing its ID (which may be a unique string of numbers and/or characters), tile-specific-information and whether neighboring tiles are connected to it (step 1424), which may be routed back to the MPU through the marked connector (step 1426, note that if there are more display tile on the way between the display tile and the MPU, each of them has already received the tileID message prior to designated display tile, and therefore may route the message through its own marked connector). In some embodiments, in the MPU, the reply message is parsed and the map/graph of the tile array is updated with the newly found display tile information. In addition, the MPU creates IDReq for every neighboring display tile reported in the message (including the correct route to reach them) and adds them to the processing queue. The queue is then checked again for members (condition 1414) and the process repeats itself. In case the display tile receiving the message has already received such a tileID message, it may route the message to its correct destination through one of its connectors—according to the first letter in the routing sequence included in the tileID message, not before updating the routing sequence by removing this first letter (step 1430). When all the queue is processed and no more members are left, then the mapping of the entire tile array is complete and the MPU may indicate so to users (step 1432). This concludes the description of the proposed method of mapping a tile array by an MPU. Other methods are also possible, that may not be based on exchanging messages such as using dedicated electrical signals over MPU and display tiles connectors.

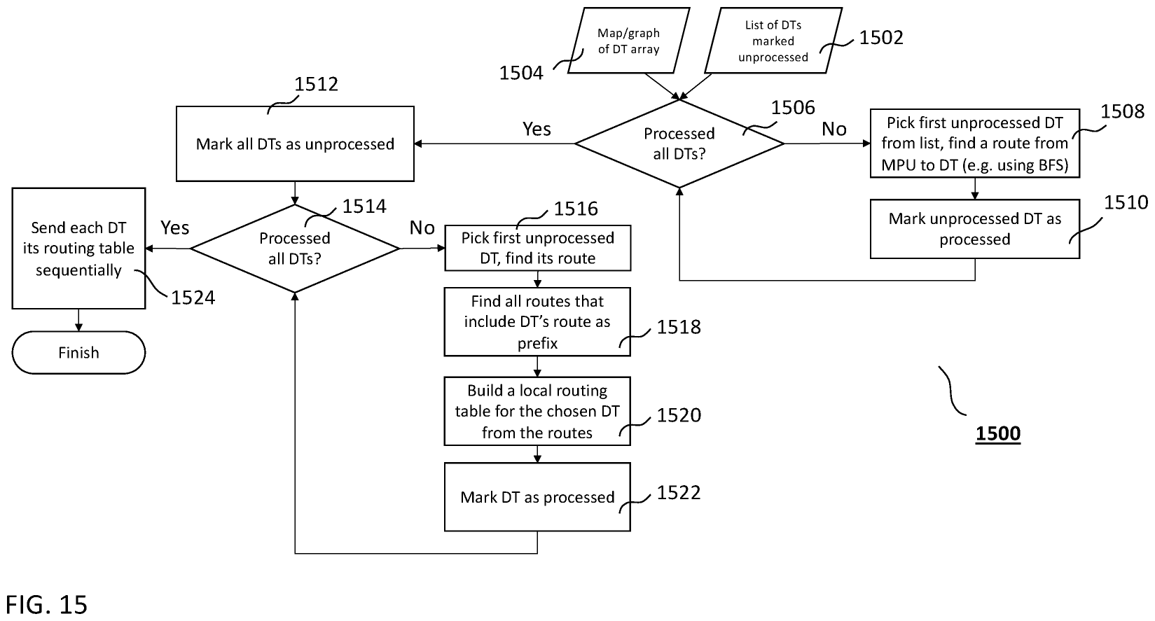

In some embodiments, following the mapping of the display tiles array, and the creation of a representation of such array in the MPU, an MPU may also calculate and distribute message-routing tables to the different display tiles in the display tiles array. Message-routing tables indicate to a display tile where (i.e. to which connector) to route an incoming message, so that it will be able to reach its destination when it travels through the display tiles array. In some embodiments, a routing table may be based on the destination display tile—for example, when a message is received at a certain display tile, it may parse the message, extract its destination and decide on a routing direction based on this destination (according to the internal routing table the display tile keeps). In some embodiments, a routing table may be based on order of arrival—for example, during a single frame cycle, the first 50 message arriving at a certain display tile should be processed by the tile, the next 40 messages arriving at the display tile should be routed one way, the next 60 messages arriving at the display tile should be routed another way, etc. FIG. 15 shows a flow diagram for generating per-display-tile routing tables by the MPU and for distributing them among display tiles (referred to as DT) in a connected display tiles array. This flow assumes that the MPU already has a representation of tile array (i.e. that the mapping of tile array procedure has already been done by the MPU). In some embodiments, two inputs may be required—a list of display tiles 1502, all marked as “unprocessed”, and a map or graph of tile array 1504. In some embodiments, the processing flow may start by an iterative process, in which a route may be found from the MPU to each of the display tiles. First, condition 1506 may check whether all display tiles in the list have been processed. If not, in step 1508, an unprocessed display tile may be picked from the list, and a route may be found from the MPU to the display tile. The route may consist of a sequence of letters, numbers or signs that is given to each connector in a display tile, marking in each position the routing direction that should be taken when a message reaches a certain display tile along its path from the MPU to the destination display tile. For example (following the same notation used before), a sequence of N-N-E-S-S-W means that the first display tile following the MPU routes the message through its N connector, the second display tile also routes it through the N connector, the third display tile routes it through its E connector, the fourth display tile routes it through its S connector, the fifth display tile also routes the message through its S connector, and the sixth display tile routes it through its W connector. Then, the message reaches the destination display tile. In some embodiments, after a route is found, the display tile may be marked as processed (step 1510) and the next display tile on the list may be processed, until all display tiles have been marked as processed. In some embodiments, finding routes for display tiles may be done, for example, by representing the tile array as a graph, with the display tiles being the nodes of the graph and physical connections between two adjacent display tiles being edges, and the MPU being the root of the graph, traversing the graph from the root (e.g. using breadth-first search approach) while keeping record of the chosen path from the root (i.e. connectors in each display tile) and whenever reaching an unvisited node, assigning to the display tile represented by this node, the chosen path up to this node as its route. In some embodiments, after all display tiles have been processed, the second phase of the flow may begin—the display tiles on the list may again be marked as unprocessed (step 1512), then an iterative process may start, until all the display tiles have been marked processed (condition 1514). In some embodiments, in this iterative process, first an unprocessed display tile may be picked along with the route assigned to it (step 1516). Then, in step 1518, from all the routes assigned to display tiles, routes may be found which contain the picked display tile's route as a prefix (for example, the route N-W-W-N-N contains the route N-W as a prefix). These routes belong to display tiles that should appear on the routing table of the picked display tile. From this list of prefix-matched routes, a local routing table is built for the picked display tile (step 1520). This local routing table may also include the picked display tile itself (for it to handle messages addressed to it). The display tile is then marked as processed (step 1522). Once all display tiles have been processed, the MPU may send each display tile its routing table sequentially, possibly according to a routing order (i.e. making sure to send messages containing routing tables to display tiles in an order that guarantees all display tiles in route already received their own routing tables and are able to route these messages to their destination), or in the same manner as described in the process of mapping tile array (step 1430).

### Streaming

In some embodiments, during streaming phase, an MPU may receive incoming streams from external devices, may combine them into a single stream of frames (for example, according to user choice and other factors), and send a certain part of the frame information to each display tile in a connected display tiles array, according to its position, how the frames should be presented, etc. In some embodiments, an MPU may send only partial frame information to a display tile, which may interpolate missing values locally, before displaying the frame. Frame data may be sent from an MPU to a display tile over a data channel and may be routed through display tiles in the display tiles array, using local routing tables, until it reaches its destination.

In some embodiments, during streaming, the MPU may monitor and/or to modify some system parameters, based on addition/removal of display tiles, user input (for example, such as touch-gestures from display tiles supporting touch or user commands from an application running on a mobile device), addition/removal of input streams, etc. These parameters may include, for example, the sizes, resolution and aspect ratio of the stream of frames it produces, the way incoming streams are combined together into one frame, the format and resolution of data sent to each display tile in the display tiles array, the routing tables used to route messages, the common refresh rate of the tile array (at which display tiles update their displayed content), the data refresh rate (at which an MPU updates data) for different parts of the display tiles array, etc.

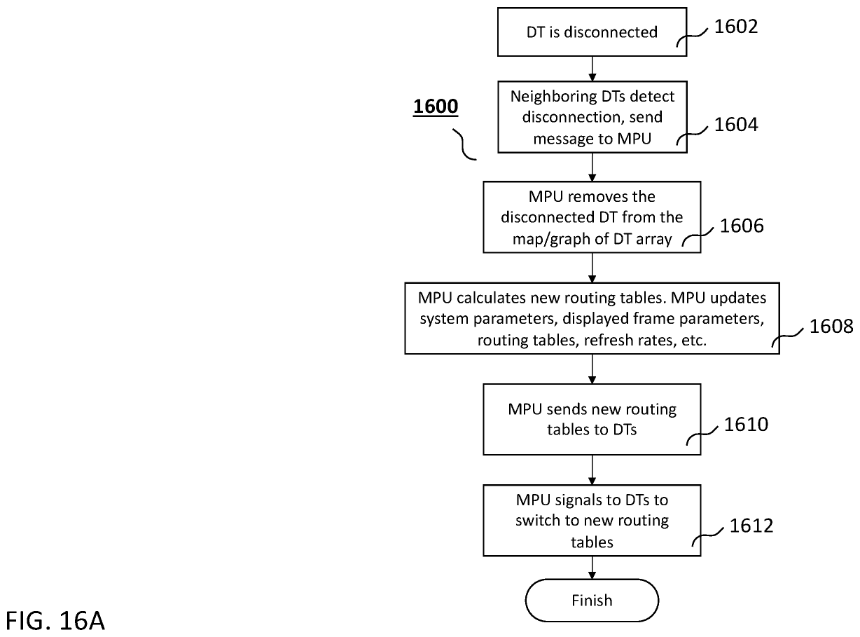

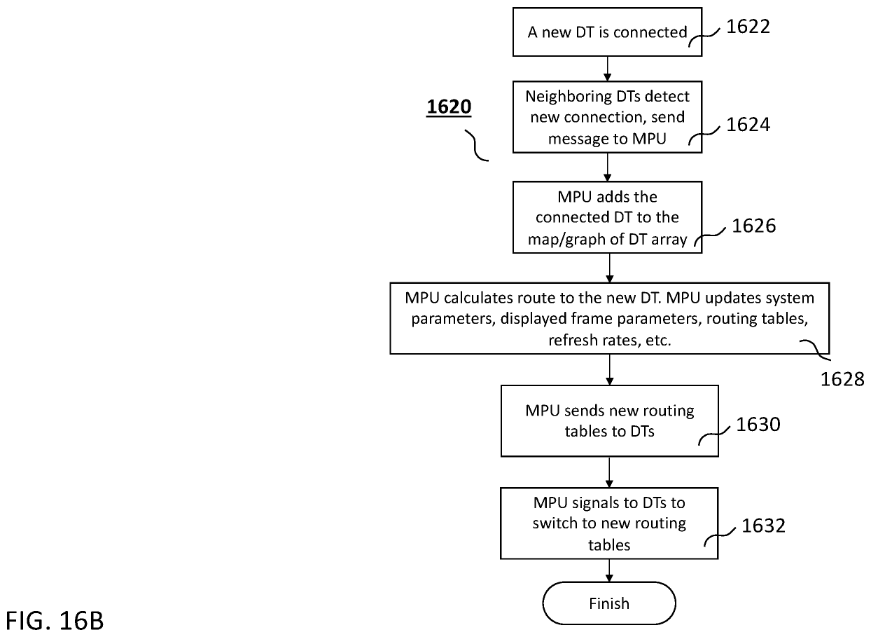

FIG. 16A and FIG. 16B show how an MPU may handle disconnection of display tiles from a tile array or connection of new display tiles to a display tiles array, during streaming. In FIG. 16A, flow 1600 illustrates the steps taken in some embodiments by display tiles in a tile array and by an MPU when a display tile is disconnected (step 1602) during streaming. Upon disconnection, display tiles that were connected to the disconnected display tile may not receive power (e.g. if no other display tile is connected to them and can supply power) and may therefore seize to function. Even if such display tiles do get power from other connected display tiles, these display tiles may not be able to update their displayed content if messages containing frame data addressed to them were routed through the disconnected display tile. However, at least one display tile may be able to detect the disconnection (for example, via mechanisms described earlier in section “Display tiles structure”). A message about the disconnected display tile is sent to the MPU (step 1604) and the MPU may take action as a result of the disconnection: it may update the data structures representing the tile array (step 1606), such as a map or a graph, it may calculate new routing tables for routing messages between display tiles, it may update system parameters and the displayed frame parameters (step 1608). Following the update, the MPU may send new routing tables to display tiles (step 1610) and then, in some embodiments, it may signal to all the display tiles to update their routing tables concurrently (step 1612), via a dedicated signal (similar to the frame-refresh synchronization signal discussed earlier in section “Display tiles structure”).

Similarly, as shown in FIG. 16B, in some embodiments, when a new display tile is connected to the tile array during streaming, a sequence of actions 1620 may take place. Neighboring display tile may detect the newly connected display tile and send a message to the MPU (step 1624). The MPU may update the data structures (such as a map or a graph) representing the tile array (step 1626) to reflect the newly connected display tile. The MPU may then calculate a route to the new display tile, update routing table in neighboring display tiles and possible update system parameters, displayed frame parameters, etc. (step 1628). The new routing tables may then be sent to some display tiles in the tile array (step 1630) and the MPU may then signal to all the display tiles to update their routing tables concurrently (step 1632), via a dedicated signal.

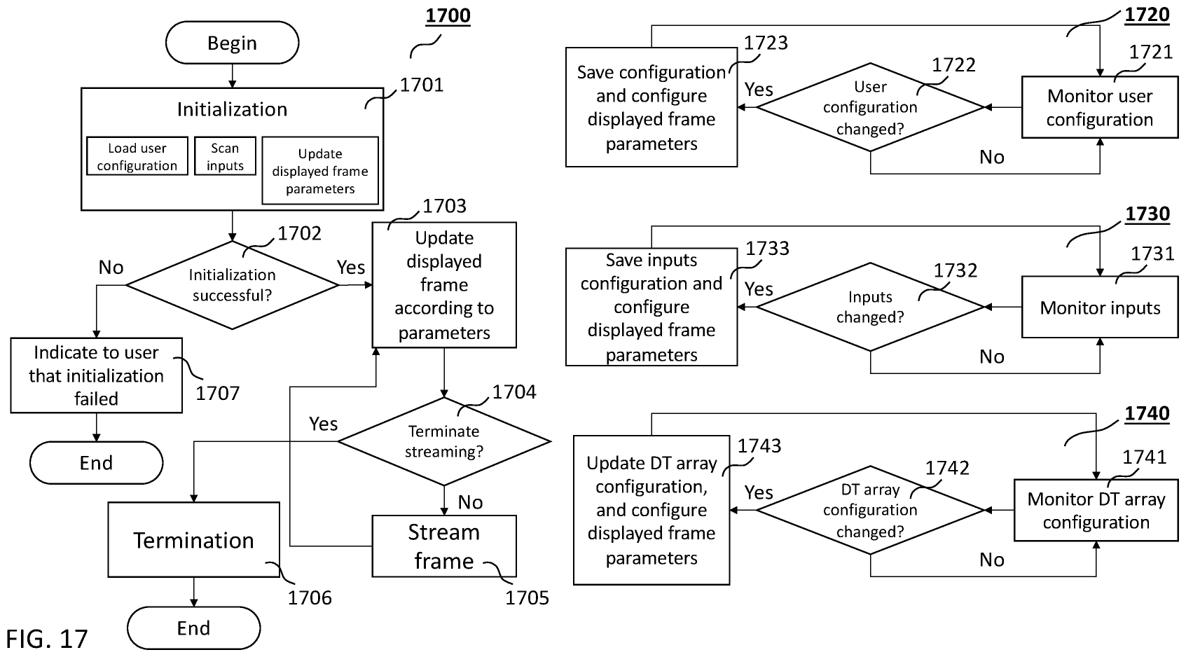

In some embodiments, an MDS may operate according to operational flow described in FIG. 17. FIG. 17 shows a block diagram illustrating main operational flow 1700, and secondary operational flows 1720, 1730 and 1740. In some embodiments, main operational flow 1700 and secondary operational flows 1720, 1730 and 1740 are executed on an MPU. In some embodiments, operational flow 1700 may begin upon system bring-up (for example, after system power is turned on), with an initialization step 1701. As described above, initialization step 1701 may include several operations, such as, for example, loading user configuration scanning input streams from external devices, updating displayed frame parameters, etc. After initialization step 1701, in step 1702 condition verifies that initialization was successful. If unsuccessful, in step 1707, an indication is given to the user (this indication may include showing some light, showing an indication on a mobile device, on a remote control, etc.). If initialization is successful, in step 1703 displayed frame is updated according to parameters and content from input stream and if operation was not terminated (condition checked in step 1704), frames are streamed from MPU to tile array (step 1705). If operation is terminated, termination step 1706 takes place and MDS operation is terminated. Termination step 1706 may include stopping streaming, disconnecting power to display tiles, saving information into non-volatile memory, cleaning up and freeing used resources, etc. After step 1705 is the system continuously updates the displayed frame and streams the frame to the tile array (steps 1703, 1704 and 1705 repeat continuously, until termination). In some embodiments, in parallel to main operational flow 1700, an MPU may execute flow 1720 in which it may monitor user configuration (step 1721), and if a change occurs (condition 1722), it may save the new configuration, calculate possible updates to the displayed frame parameters and update them, if required (step 1723). As an example, a change in user configuration may include enlarging one particular part of the displayed stream, modifying frame rate, scrubbing a part of the stream (going back and forward in time), changing colors, contrast and other parameters of a part of a stream, etc. In some embodiments, in parallel to main operational flow 1700, an MPU may execute flow 1730 in which it may monitor input streams from external devices to the MPU (step 1731), and if a change occurs (condition 1732), it may save the new status of input streams, calculate possible updates to the displayed frame parameters and update them, if required (step 1733). As an example, a change for example, a change in input streams may include the addition of one or more input streams, the removal of one or more input existing input streams, or a change in parameters (such as, for example, resolution, size, frame rate, etc.) of one or more existing input streams. In some embodiments, in parallel to main operational flow 1700, an MPU may execute flow 1740 in which it may monitor the configuration of the tile array (step 1741), and if a change occurs (condition 1742), it may update the new status of display tiles (see FIG. 16A and FIG.16B and related explanation), calculate possible updates to the displayed frame parameters and update them, if required (step 1743). As an example, a change in tile array may be the addition or removal of one or more display tiles, modifying the spatial arrangement of display tiles, etc. Secondary operational flows 1720, 1730 and 1740 may result in updating the parameters of displayed frame. These parameters may take effect in step 1703, when the displayed frame is be updated by the MPU.

Returning now to FIG. 13, in some embodiments, communication channels between MPU 1320 and display tiles 1310 may include wireless communication channels, over which frame data and/or control messages to be displayed may be sent directly from MPU 1320 to each of or to some display tiles in tile array 1310 and back from each of or from some display tiles in tile array 1310 to MPU 1320, in addition to transferring control signals via wired communication, propagating through tile array or broadcasted to entire array, as explained above. When direct communication is available between MPU 1320 to display tiles in tile array 1310, for such messages that are transmitted directly (typically, these include but are not limited to: the frame data for each display tile, or for some display tiles of the display tiles in tile array 1310, and/or control messages), there is no need for routing the messages in the array from tile to tile, until they reach their destination. There is, however, a need to establish direct communication protocol between MPU 1320 and display tiles in tile array 1310. Such a protocol may be established during initialization phase, and it may be updated when a new display tile is added or removed to/from tile array 1310. In some embodiments, frame data and some control messages may be transferred from MPU 1320 to some or all display tiles in tile array 1310 and back, over direct wireless channels, while other frame data and some control messages and/or signals (for example, synchronization signal), may be transferred from MPU 1320 to some or all display tiles in tile array 1310 and back, over wired communication channels.

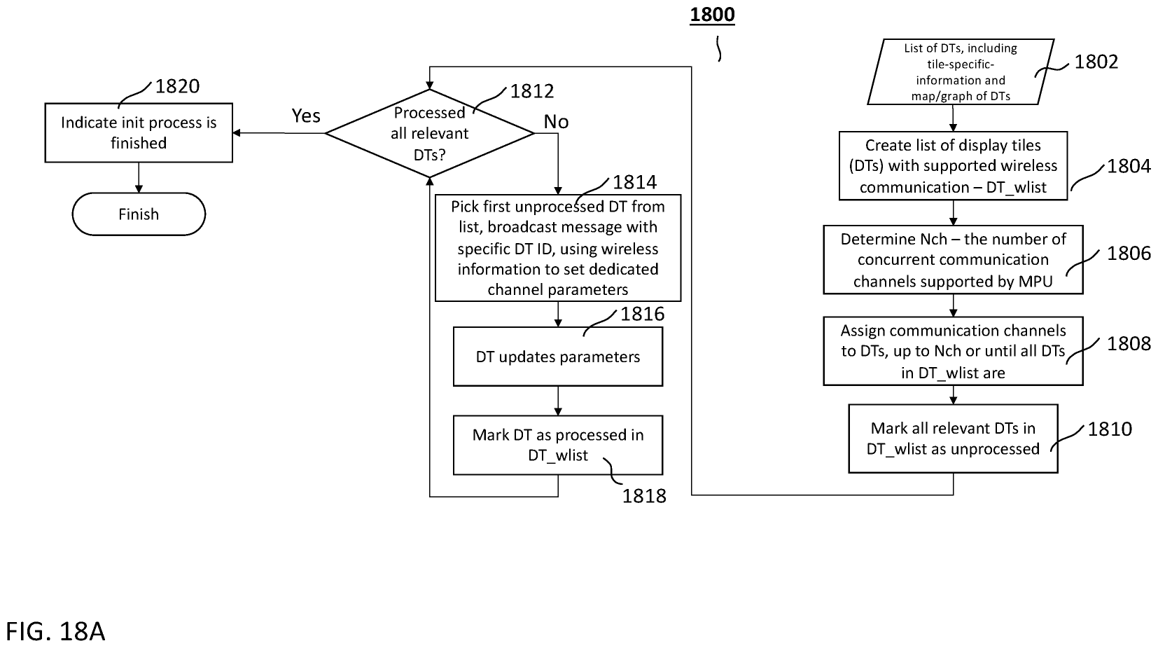

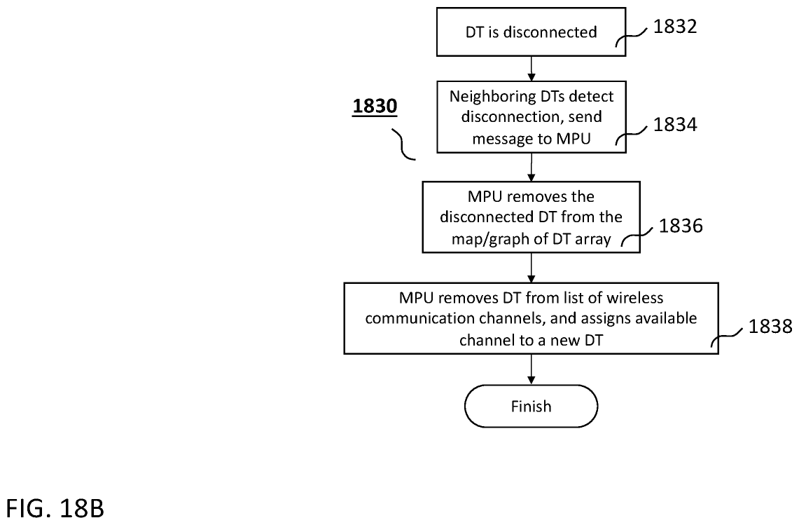

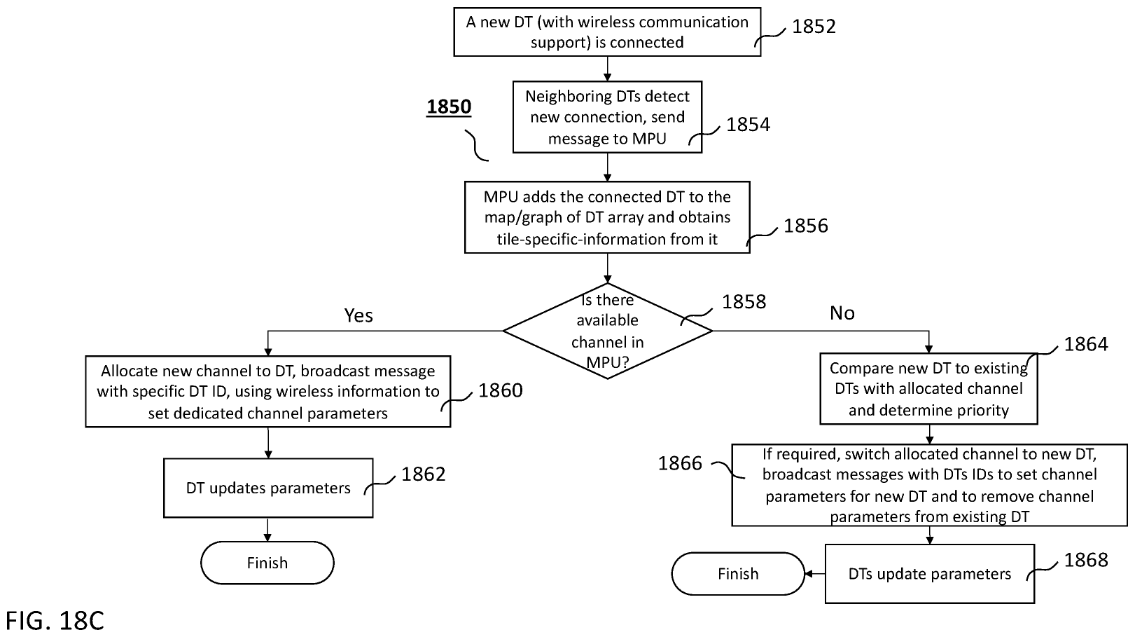

Exemplary, FIG. 18A describes an initialization flow that, in some embodiments, may be performed in MPU 1320 where wireless communication channels need to be established with some or all display tiles in tile array 1310. During initialization stage, after the mapping of tile array and obtaining display tiles information (as described in FIG. 14 and the text referring to it), MPU 1320 receives a list of display tiles 1802, including an ID for each display tile and information required for establishing wireless communication channel (as previously described in initialization phase, including but not limited to, for example, channel number, frequency, address, type of communication protocol, etc.), and in addition, a map or graph describing the connections between display tiles. In some embodiments, MPU 1320 may then create a list of display tiles that support wireless communication (step 1804), denoted “DT_wlist” herein, and determine the number of concurrent communication channels that may be supported by it (step 1806), denoted Nch herein. MPU 1320 may then assign communication channels to display tiles in DT_wlist, until all Nch channels are allocated (step 1808)—assigning channels to display tiles may be done according to different parameters, including, but not limited to: the distance of the display tile from the MPU (i.e. how many display tiles in the shortest path between the MPU and said display tile—typically, the longer the path, the more it may be beneficial to use wireless communication), the display tile resolution, tile-specific-information and other parameters. These channels may be used concurrently, in time, for sending frame data and/or control information between MPU 1320 and display tiles 1310. In steps 1810 to 1820, MPU 1320 notifies relevant display tiles about the communication channel parameters so that communication channels may be established with each. In step 1810, relevant display tiles in list DT_wlist are marked unprocessed, and the list is checked whether all tiles have been processed (step 1812). If a certain display tile on the list is still marked as non-processed, an initial communication channel is established with that display tile (for example, using wireless communication information and tile ID obtained from the tile during initialization described in FIG. 14 and text referring to it), and new channel parameters (e.g. frequency, channel number, bandwidth, encryption parameters, protocol information, etc.), are sent from MPU 1320 to said display tile (step 1814), which in turn may configure itself accordingly (step 1816). Once communication channel is established with new parameters (this channel may then be used during streaming operation), the display tile is marked as processed in DT_wlist (step 1818). The wireless communication initialization flow is concluded when all relevant display tiles in DT_wlist (step 1820). Exemplary, FIG. 18B shows a flow 1830 that handles a case where a display tile connected to MPU in a wireless connection is disconnected from the display tiles array. When such a display tile is disconnected (step 1832), neighboring display tiles in tile array 1310 detect this and send a message to MPU 1320 (step 1834). MPU 1320 removes the disconnected display tile from the map/graph of the tile array (step 1836), and also from the list of wireless communication channels, and it may assign the available wireless communication channel to a different display tile (step 1838). Exemplary, FIG. 18C shows a flow 1850 that handles a case where a new display tile is connected to display tiles array. In some embodiments, when a new display tile with wireless communication capability is connected to a tile array (step 1852), neighboring display tiles may detect the newly-connected display tile and send message to the MPU (step 1854)—as described earlier. The MPU may update its map/graph of display tile and obtain tile-specific information from the newly connected display tile (step 1856). If a wireless communication channel is available in the MPU (step 1858), the MPU may allocate the free channel to the newly connected display tile, send channel parameters to it (step 1860) and after the display tile updates the wireless communication parameters (Step 1862), the MPU and the newly-connected display tile may exchange information wirelessly. If there is no available channel in the MPU, it may need to determine (in step 1864) whether to keep the current wireless channel allocation as it is (in which case, it may communicate with the newly-connected tile over wire-based communication channel), or whether to deallocate an already-allocated wireless communication channel and use it for the newly connected display tile. In some embodiments, such a decision may depend on several factors, such as the new display tile resolution, its distance from the MPU and the latency of transferring information to it. As a non-limiting example, if the latency of transferring frame information to that display tile is higher than the expected latency of transferring frame information over wired communication channel to each of display tiles that are currently wirelessly connected to the MPU, and is also higher than transmitting the frame information wirelessly to the newly-connected display tile, then allocating a wireless channel to the newly connected display tile may improve overall latency of transmitting to all display tiles, and may therefore be preferable. In such a case, the MPU may decide to evict the display tile with the least latency when using wire-based communication from the list of display tiles with allocated wireless-communication channels. Once priority of using wireless communication channels is set in step 1864, the MPU may broadcast messages to display tiles, setting wireless channel parameters to the newly connected display tile and updating one of the existing display tiles not to use the wireless channel (step 1866). The process is complete after the display tiles update their parameters (step 1868).

### MPU as Integral Part of Tile Array

Returning now to FIG. 1, the figure shows MDS 100 comprising (among other parts) tile array 120 and MPU 101. MPU 101 is shown as a separate unit, connected to tile array 120 via cable 104 and connector 106. However, in some embodiments, MPU 101 may also be implemented as an integral part of tile array 120, i.e. MPU 101 may take the shape similar to that of a display tile, may include a display and may act as part of tile array 120. It may be called an MPU tile. As such, MPU 101 may also include touch-capabilities, and may connect to display tiles in tile array 120 using the same connectors that connect different display tiles to each other. This section discusses the structure of an MPU tile and teaches a possible mechanical design for it.

Returning now to FIG. 2D, the figure shows such a configuration. In FIG. 2D, MPU tile 242 is part of display tile arrays 240, and includes a display that can show image content, much like display tiles such as display tile 241. Exemplarily, in FIG. 2D the size of MPU tile 242 equals the size of 2×2 standard display tiles. However, the size of MPU tile 242 may be smaller or larger (e.g. 1×1, 1×2, 3×2, 3×3, 4×2, etc. and any other configuration that permits connecting it to display tiles by keeping the standard display tile interface). As shown in FIG. 3C, tile array 300 is mounted on ferromagnetic layer 350 that includes display tiles 360 and MPU tile 370, which functions also as a display tile. MPU tile 370 is connected to electrical socket 380 through electrical cable and connector 382, to provide power to tile array 300. In some illustrative embodiments, shown in FIG. 3D, MPU tile 372, which is part of tile array 300 is placed on top of electrical socket 384, and is connected directly to it, without the need to use visible wires, which may be beneficial, design-wise, for users (electrical socket 384 is depicted in dashed lines, to mark its position behind MPU tile 372).

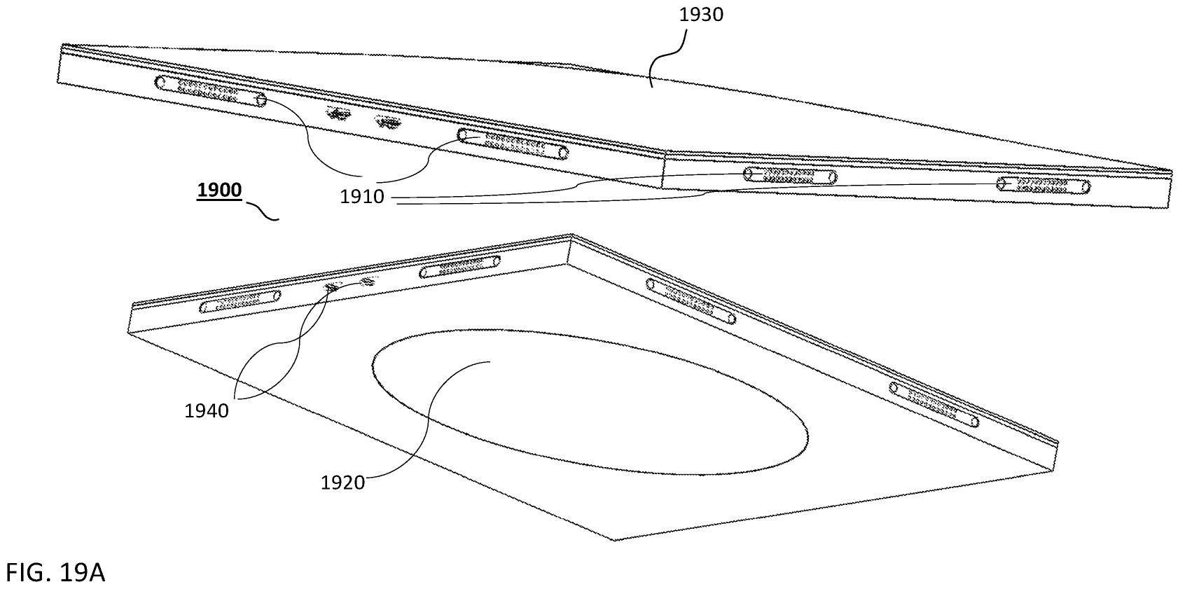

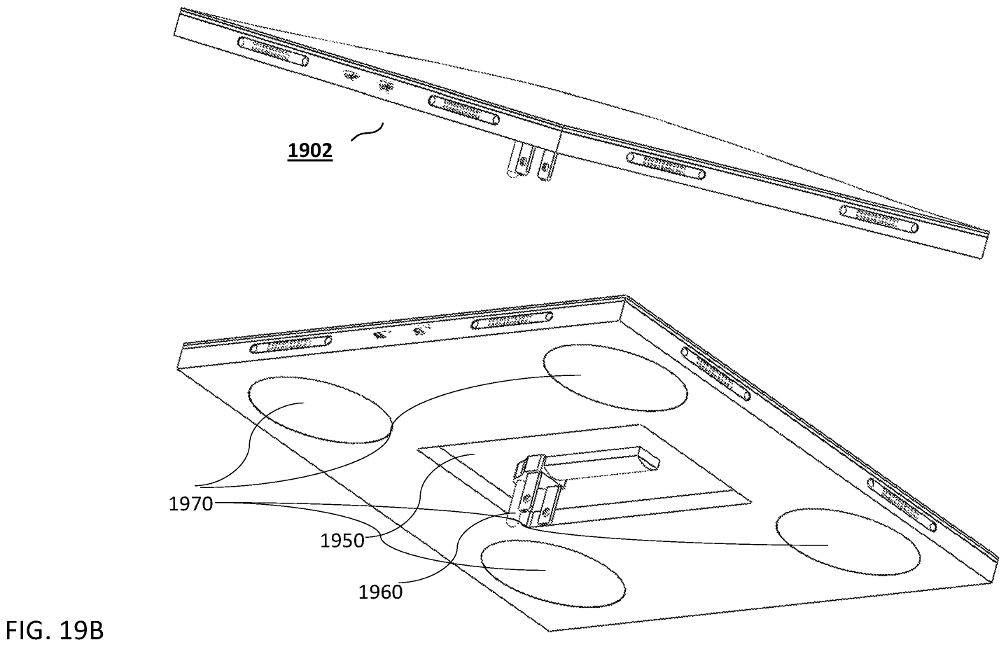

FIG. 19A shows an illustrative embodiment of an MPU tile that is part of a display tiles array. MPU tile 1900 is shown from two angles of view (from the top and from below). Exemplary, MPU tile 1900 size is equal to the size of two display tiles, and it includes two standard display tile connectors 1910 on each side (to support connection to two display tiles on each side), magnet 1920 on the bottom side, and may also include optical element 1930 on its top side (similar to standard display tiles). In some embodiments, MPU tile 1900 may also include connectors to external devices, for example HDMI connectors 1940, that allow connecting external sources of content (other connectors, as described in connector interface 102, may also be part of MPU tile 1900 side). FIG. 19B shows another illustrative embodiment of MPU tile 1902, similar to MPU tile 1900, which, may include depression 1950 that is slightly larger than the size of a standard electrical socket, magnets 1970 and electrical plug 1960, that allow placing MPU tile 1902 above an electrical socket, covering it and connecting to it to supply power to MPU tile 1902 and to display tiles connected to it.

The various features and steps discussed above, as well as other known equivalents for each such feature or step, can be mixed and matched by one of ordinary skill in this art to perform methods in accordance with principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein.

Unless otherwise stated, the use of the expression “and/or” between the last two members of a list of options for selection indicates that a selection of one or more of the listed options is appropriate and may be made.

It should be understood that where the claims or specification refer to “a” or “an” element, such reference is not to be construed as there being only one of that element.

It is appreciated that certain features, which are, for clarity, described in the context of separate embodiments or example, may also be provided in combination in a single embodiment. Conversely, various features, which are, for brevity, described in the context of a single embodiment, may also be provided separately or in any suitable sub-combination or as suitable in any other described embodiment. Certain features described in the context of various embodiments are not to be considered essential features of those embodiments, unless the embodiment is inoperative without those elements.

Citation or identification of any reference in this application shall not be construed as an admission that such reference is available as prior art to the present application.

What is claimed is:

1. A display system comprising:
a) a display tiles array comprising a plurality of display tiles; and
b) a main processing unit (MPU),
wherein each display tile is connected electrically to at least one other display tile, wherein the MPU is coupled electrically to at least one of the display tiles via an electrical connection, wherein the MPU may transmit information to the display tiles array via the electrical connection, and wherein the transmitted information may propagate to particular display tiles in the display tiles array such that each particular display tile may receive and display information intended to the respective particular display tile.

2. The display system of claim 1, wherein the transmitted information includes image frame data.

3. The display system of claim 1, wherein the transmitted information includes still images.

4. The display system of claim 1, wherein each display tile is connected magnetically to at least one other display tile.

5. The display system of claim 1, wherein each display tile is mounted magnetically on a ferromagnetic surface.

6. The display system of claim 1, wherein at least one display tile may be touch sensitive and may have touch-screen abilities.

7. The display system of claim 1, further comprising means for user interaction with the display system to control display system parameters.

8. The display system of claim 7, wherein the user interaction is done through touch gestures on touch sensitive display tiles.

9. The display system of claim 1, wherein each display tile includes a tile processing unit, non-volatile memory and data and control interfaces.

10. The display system of claim 9, wherein at least some of display tiles include a display.

11. The display system of claim 1, wherein at least some display tiles include an optical element that applies optical magnification to displayed tile image and diminishes observed bezels around it.

12. The display system of claim 1, wherein at least some information propagates between the MPU and the plurality of display tiles and between display tiles in the display tiles array by means of messages that are routed to their respective destination display tiles according to routing tables in each display tile.

13. The display system of claim 12, wherein the MPU is configured to map the array of display tiles by sending identification messages and to construct a representation of display tiles array, including information about the type of each display tile and its connections to other display tiles.

14. The display system of claim 1, wherein the display tiles include connectors on each side that connect magnetically to connectors in neighboring display tiles.

15. The display system of claim 14, wherein side connectors in each display tile include permanent magnets oriented with outward-facing magnetic poles alternating between north and south along a circumference of the display tile.

16. The display system of claim 1, wherein the MPU is an integral part of the display tiles array and includes an MPU display.

17. The display system of claim 16, wherein the MPU display is a touch-sensitive display, allowing for user interaction through touch gestures.

18. The display system of claim 16, wherein the MPU further includes a depression and electrical plug to support mounting it on top of an electrical socket.

19. A display system comprising:
a) a display tiles array comprising a plurality of display tiles, at least some of which have wireless communication capabilities; and
b) a main processing unit (MPU) having wireless communication capabilities,
wherein each display tile is connected electrically to at least one other display tile, wherein the MPU is coupled electrically to at least one of the display tiles via an electrical connection and wherein the MPU may transmit information to at least some of plurality of display tiles via wireless communication.

20. The display system of claim 19, wherein the MPU is configured to send a synchronization signal to at least some of display tiles to synchronize the time in which the display tiles update the displayed frame information.
